(19) United States
(12) Patent Application Publication
(10) Pub. No.: US 2026/0313256 A1
(43) Pub. Date: Oct. 8, 2026

(54) LIGHT DETECTION DEVICE, CORRECTION METHOD, AND PROGRAM

(71) Applicant: SONY SEMICONDUCTOR SOLUTIONS CORPORATION, KANAGAWA (JP)

(72) Inventors: YUKI NISHINA, KANAGAWA (JP); KOJI MATSUURA, KANAGAWA (JP); HIROSHI KINUGAWA, KANAGAWA (JP)

(21) Appl. No.: 19/481,882

(22) PCT Filed: Apr. 25, 2024
(86) PCT No.: PCT/JP2024/016193

§ 371 Date: Nov. 5, 2025

(30) Foreign Application Priority Data
May 11, 2023 (JP) 2023-078373

(51) Int. Cl. H04N 25/47; H04N 25/671

(52) U.S. Cl. CPC H04N 25/47; H04N 25/671

(57) ABSTRACT

The present technology relates to a light detection device, a correction method, and a program that can reduce effects of interference between a gradation signal and an event signal. The present technology includes a pixel array section including a plurality of pixels disposed in a two-dimensional matrix, the pixel including an event data generation section configured to detect, as an event, a change in luminance of incident light in the same direction and generate event data based on the event that is detected and a gradation data generation section configured to generate gradation data that is data corresponding to the luminance of the incident light; an interference intensity identification section configured to identify an intensity of interference generated by an overlap between a period in which the gradation data is generated and a period in which the event is detected; and a correction section configured to correct the event data according to the intensity of the interference identified by the interference intensity identification section. The present technology can be applied to, for example, a light detection device that acquires a gradation signal and an event signal.

### TECHNICAL FIELD

The present technology relates to a light detection device, a correction method, and a program, and, for example, relates to a light detection device, a correction method, and a program that improve an accuracy of event detection.

### BACKGROUND ART

For example, as known as an event-based vision sensor (EVS), there is a sensor device that detects, for each pixel, an event signal representing a change in a light reception amount. In this type of sensor device, there is a sensor device in which a pixel for event signal detection and a pixel for gradation signal detection are mixed, making it possible to acquire a gradation signal (signal indicating an intensity of a light reception amount) of a pixel in which an event has been detected (refer to PTL 1, for example).

### CITATION LIST

### Patent Literature

PTL 1: JP 2021-129265 A

### SUMMARY

### Technical Problem

In the related art described above, the processing of generating the gradation signal and the processing of detecting the event overlap in time, resulting in a possibility of interference caused by a control signal or the like. When interference occurs, there is a possibility that an error occurs in the event signal. A reduction in the effects of interference and an improvement in the accuracy of event signals are desired.

The present technology has been made in view of such circumstances, and an object thereof is to improve an accuracy of an event signal.

### Solution to Problem

A light detection device according to an aspect of the present technology includes a pixel array section including a plurality of pixels disposed in a two-dimensional matrix, the plurality of pixels each including an event data generation section configured to detect, as an event, a change in luminance of incident light in the same direction and generate event data based on the event that is detected and a gradation data generation section configured to generate gradation data that is data corresponding to the luminance of the incident light; an interference intensity identification section configured to identify an intensity of interference generated by an overlap between a period in which the gradation data is generated and a period in which the event is detected; and a correction section configured to correct the event data according to the intensity of the interference identified by the interference intensity identification section.

A correction method according to an aspect of the present technology is a correction method executed by a light detection device including a pixel array section including a plurality of pixels disposed in a two-dimensional matrix, the plurality of pixels each including an event data generation section configured to detect, as an event, a change in luminance of incident light in the same direction and generate event data based on the event that is detected and a gradation data generation section configured to generate gradation data that is data corresponding to the luminance of the incident light. The correction method includes identifying an intensity of interference generated by an overlap between a period in which the gradation data is generated and a period in which the event is detected, and correcting the event data according to the intensity of the interference that is identified.

A program according to an aspect of the present technology is a program for causing a computer configured to control a light detection device, the light detection device including a pixel array section including a plurality of pixels disposed in a two-dimensional matrix, the plurality of pixels each including an event data generation section configured to detect, as an event, a change in luminance of incident light in the same direction and generate event data based on the event that is detected and a gradation data generation section configured to generate gradation data that is data corresponding to the luminance of the incident light, to execute identifying an intensity of interference generated by an overlap between a period in which the gradation data is generated and a period in which the event is detected, and correcting the event data according to the intensity of the interference that is identified.

In the light detection device, the correction method, and the program according to aspects of the present technology, a pixel array section including a plurality of pixels disposed in a two-dimensional matrix is provided, the pixel including an event data generation section configured to detect, as an event, a change in luminance of incident light in the same direction and generate event data based on the event that is detected and a gradation data generation section configured to generate gradation data that is data corresponding to the luminance of the incident light. The intensity of interference generated by the overlap between a period in which the gradation data is generated and a period in which the event is detected, and the event data is corrected according to the identified intensity of the interference.

Note that the light detection device may be an independent device or may be an internal block constituting one device.

Note that the program can be provided by being transmitted via a transmission medium or by being recorded in a recording medium.

### BRIEF DESCRIPTION OF DRAWINGS

FIG. 1 is a diagram depicting a configuration example of a light detection device according to an embodiment of the present disclosure.

FIG. 2 is a diagram depicting a configuration example of a pixel.

FIG. 3 is a diagram depicting a configuration example of a gradation signal generation section.

FIG. 4 is a diagram depicting an example of generation of a gradation signal.

FIG. 5 is a diagram depicting a configuration example of an event signal generation section.

FIG. 6 is a circuit diagram depicting the configuration example of the event signal generation section.

FIG. 7 is a circuit diagram depicting the configuration example of the event signal generation section.

FIG. 8 is a diagram depicting an example of generation of a gradation signal and an event signal.

FIG. 9 is a diagram depicting a configuration example of an overlap prediction row detecting unit.

FIG. 10 is a diagram depicting an example of event data.

FIG. 11 is a diagram depicting an example of a processing procedure of overlap row detection processing.

FIG. 12 is a diagram depicting a configuration example of a correction section.

FIG. 13 is a diagram depicting another configuration example of the correction section.

FIG. 14 is a diagram depicting another configuration example of the correction section.

FIG. 15 is a diagram depicting another configuration example of the correction section.

FIG. 16 is a diagram for describing event data before correction and after correction.

FIG. 17 is a diagram for describing event data before correction and after correction.

FIG. 18 is a flowchart for describing processing related to correction of event data.

FIG. 19 is a flowchart for describing first interference intensity identification processing.

FIG. 20 is a diagram for describing an HOPB region.

FIG. 21 is a diagram for describing conditions related to identification of interference intensity.

FIG. 22 is a flowchart for describing second interference intensity identification processing.

FIG. 23 is a diagram for describing conditions related to identification of interference intensity.

FIG. 24 is a flowchart for describing third interference intensity identification processing.

FIG. 25 is a diagram depicting an example of an interference intensity LUT 621.

FIG. 26 is a flowchart for describing first event data correction processing.

FIG. 27 is a diagram for describing removal of a noise event.

FIG. 28 is a diagram for describing a first correction rule.

FIG. 29 is a diagram for describing a second correction rule.

FIG. 30 is a diagram for describing a third correction rule.

FIG. 31 is a flowchart for describing second event data correction processing.

FIG. 32 is a diagram showing a relationship between interference intensity and correction factor.

FIG. 33 is a diagram depicting a configuration example of a PC.

FIG. 34 is a block diagram depicting a schematic configuration example of a vehicle control system.

FIG. 35 is an explanatory view depicting an example of an installation position of an outside-vehicle information detecting unit and an imaging section.

### DESCRIPTION OF EMBODIMENTS

Hereinafter, modes for carrying out the present technology (hereinafter, embodiments) will be described.

### Configuration of Light Detection Device

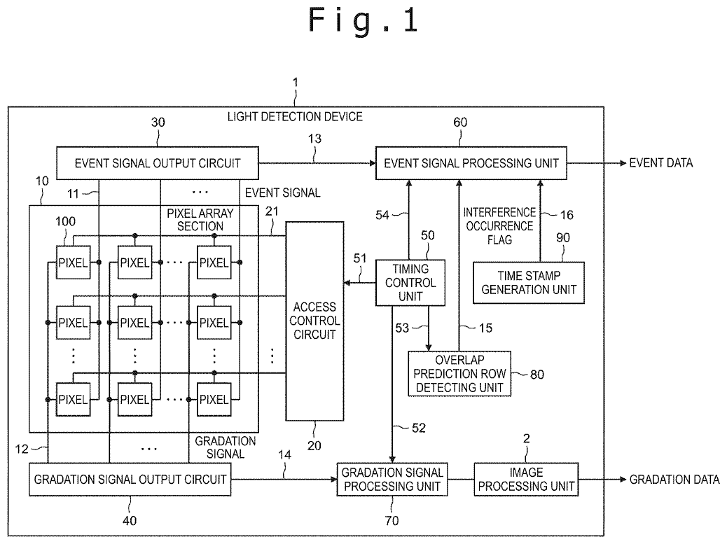

FIG. 1 is a diagram depicting a configuration according to an embodiment of a light detection device to which the present technology is applied.

A light detection device 1 includes a pixel array section 10, an access control circuit 20, an event signal output circuit 30, a gradation signal output circuit 40, a timing control unit 50, an event signal processing unit 60, a gradation signal processing unit 70, and an overlap prediction row detecting unit 80. In addition, the light detection device 1 further includes a time stamp generation unit 90 and an image processing unit 2.

The pixel array section 10 is configured by disposing a plurality of pixels 100 in a two-dimensional matrix. Here, the pixel 100 generates a gradation signal that is a signal corresponding to a luminance of incident light. Further, the pixel 100 detects, as an event, a change in the luminance of the incident light described above in the same direction, and further generates an event signal that is a signal based on the detected event. This pixel 100 includes a photoelectric conversion section that photoelectrically converts incident light, and generates the gradation signal and the event signal described above on the basis of a result of the photoelectric conversion.

A photodiode, for example, can be used as the photoelectric conversion section. Signal lines 11, 12, and 21 are routed to each pixel 100. The pixel 100 is controlled by a control signal transmitted through the signal line 21 to generate the gradation signal and the event signal. Further, the pixel 100 outputs the generated gradation signal via the signal line 12 and outputs the generated event signal via the signal line 11. Note that the signal line 21 is disposed for each row of the two-dimensional matrix shape, and is routed in common to the plurality of pixels 100 disposed in one row. The signal lines 11 and 12 are disposed for each column of the two-dimensional matrix shape, and are routed in common to the plurality of pixels 100 disposed in one column.

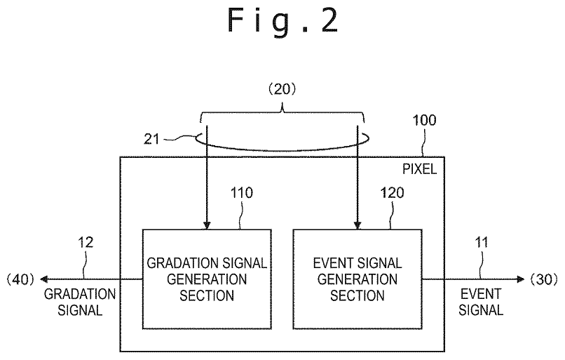

Note that, as described below with reference to FIG. 2, the pixel 100 includes a gradation signal generation section 110 that generates the gradation signal and an event signal generation section 120 that generates the event signal. Further, in the pixel array section 10, the plurality of pixels 100 disposed in the same row simultaneously generate gradation signals. The generation of this gradation signal is sequentially performed for each row while shifting the timing.

The access control circuit 20 outputs the control signal for the pixel 100 described above. The access control circuit 20 in the drawing outputs, via the signal line 12, the control signal for each row of the two-dimensional matrix of the pixel array section 10.

The event signal output circuit 30 processes an event signal for each pixel 100 output from the pixel array section 10, and outputs the processed event signal. The processing of the event signal output circuit 30 corresponds to, for example, processing of converting an analog event signal output from the pixel 100 into a digital data signal.

The gradation signal output circuit 40 processes the gradation signal generated by the pixel 100 and outputs the processed gradation signal. The gradation signal output circuit 40 in the drawing simultaneously processes gradation signals from the plurality of pixels 100 disposed in one row of the pixel array section 10. The processing of the gradation signal output circuit 40 corresponds to, for example, processing of converting an analog gradation signal output from the pixel 100 into a digital signal.

The event signal processing unit 60 processes the event signal from the event signal output circuit 30. This event signal output circuit 30 performs processing of converting the event signal into data of a predetermined format, for example. The event signal output circuit 30 outputs the processed event signal as event data to an external device.

The gradation signal processing unit 70 processes the gradation signal from the gradation signal output circuit 40. This gradation signal processing unit 70 performs processing of converting the gradation signal into data of a predetermined format, for example. The gradation signal processing unit 70 outputs the processed gradation signal as gradation data.

The timing control unit 50 controls the control of the pixel 100 and the like. This timing control unit 50 controls the pixel 100 and the like by generating and outputting the control signals for the pixel 100 and the like. This control includes control for causing the gradation signal generation section 110 to generate a gradation signal, control for causing the event signal generation section 120 to detect an event, and control for causing the event signal generation section 120 to generate an event signal based on the detected event.

The control signals used for these controls are output to the pixels 100 of each row of the pixel array section 10 via the access control circuit 20. Further, the timing control unit 50 also generates control signals for the event signal processing unit 60 and the gradation signal processing unit 70. The generated control signals are output to the access control circuit 20, the event signal processing unit 60, the gradation signal processing unit 70, and the overlap prediction row detecting unit 80. Note that the timing control unit 50 and the access control circuit 20 are an example of a row control unit.

The time stamp generation unit 90 generates and supplies a time stamp to the event signal processing unit 60.

The overlap prediction row detecting unit 80 detects an overlap prediction row that is a row where an overlap between a period in which the gradation signal is generated and a period in which an event is detected is predicted. As described above, the pixel 100 includes the gradation signal generation section 110 and the event signal generation section 120, and can individually generate the gradation signal and the event signal. Therefore, the generation period of the gradation signal and the detection period of the event may overlap. In this case, interference occurs in the generation of the gradation signal and the detection of the event.

This is caused by the fact that the gradation signal generation section 110 and the event signal generation section 120 are coupled to each other by a stray capacitor or the like and, as a result, a change in the control signal of one of the gradation signal generation section 110 and the event signal generation section 120 affects a signal level of the other. When this interference occurs, an error occurs in the gradation signal or the event signal. Here, the overlap prediction row described above is detected and used for reducing the effects of the interference. The overlap prediction row detecting unit 80 in the drawing generates an interference occurrence flag indicating the occurrence of interference on the basis of the detected overlap prediction row, and outputs the interference occurrence flag to the event signal processing unit 60.

The image processing unit 2 processes gradation data that is data of a gradation signal. Note that a configuration including an event data processing unit that processes event data that is data of the event signal may be adopted.

### Configuration of Pixel

FIG. 2 is a diagram depicting a configuration example of a pixel. The drawing is a block diagram depicting a configuration example of the pixel 100. The pixel 100 includes the gradation signal generation section 110 and the event signal generation section 120. The gradation signal generation section 110 generates a gradation signal on the basis of the control signal supplied from the access control circuit 20 via the signal line 21. The generated gradation signal is transmitted to the gradation signal output circuit 40 via the signal line 12. The event signal generation section 120 generates an event signal on the basis of the control signal supplied, via the signal line 21, from the access control circuit 20. The generated event signal is transmitted to the event signal output circuit 30 via the signal line 11.

### Configuration of Gradation Signal Generation Section

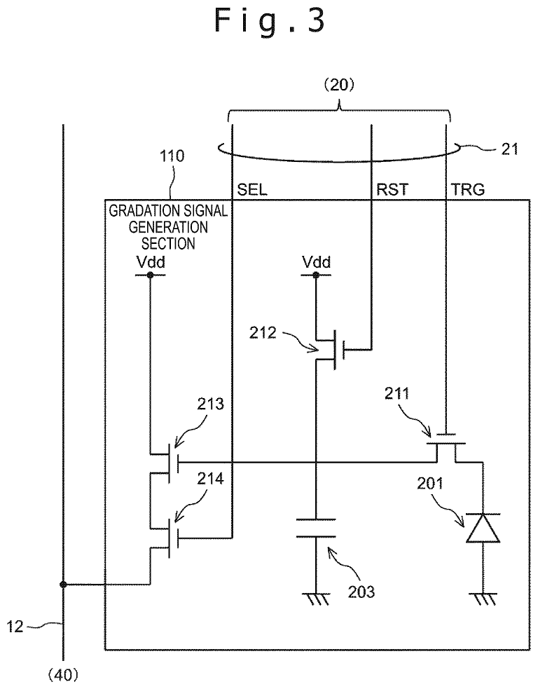

FIG. 3 is a diagram depicting a configuration example of the gradation signal generation section. The drawing is a circuit representing a configuration example of the gradation signal generation section 110. The gradation signal generation section 110 includes a photoelectric conversion section 201, a charge holding section 203, and MOS transistors 211 to 214. As the MOS transistors 211 to 214, n-channel MOS transistors can be used. The signal line 21 connected to the pixel 100 includes a signal line TRG, a signal line RST, and a signal line SEL. A power supply line Vdd for supplying power is routed to the pixel 100.

An anode of the photoelectric conversion section 201 is grounded, and a cathode of the photoelectric conversion section 201 is connected to a source of the MOS transistor 211. A drain of the MOS transistor 211 is connected to a source of the MOS transistor 212, a gate of the MOS transistor 213, and one end of the charge holding section 203. The other end of the charge holding section 203 is grounded. A drain of the MOS transistor 213 is connected to the power supply line Vdd, and a source of the MOS transistor 213 is connected to a drain of the MOS transistor 214. A source of the MOS transistor 214 is connected to the signal line 12. The signal lines TRG, RST, and SEL are connected to gates of the MOS transistors 211, 212, and 214, respectively.

The photoelectric conversion section 201 is an element that photoelectrically converts incident light. This photoelectric conversion section 201 generates and holds charges by photoelectric conversion.

The MOS transistor 211 transfers the charge held by the photoelectric conversion section 201 to the charge holding section 203. The MOS transistor 211 is controlled by a control signal transmitted by the signal line TRG.

The charge holding section 203 is an element that holds charges. This charge holding section 203 can be constituted of a semiconductor region formed in a semiconductor substrate.

The MOS transistor 212 resets the charge holding section 203. This MOS transistor 212 is controlled by a control signal transmitted by the signal line RST.

The MOS transistor 213 is an element that generates a gradation signal corresponding to the charge held by the charge holding section 203. The generated gradation signal is output to a source terminal.

The MOS transistor 214 is an element that outputs the gradation signal generated by the MOS transistor 213 to the signal line 12. This MOS transistor 214 is controlled by a control signal transmitted by the signal line SEL.

### Generation of Gradation Signal

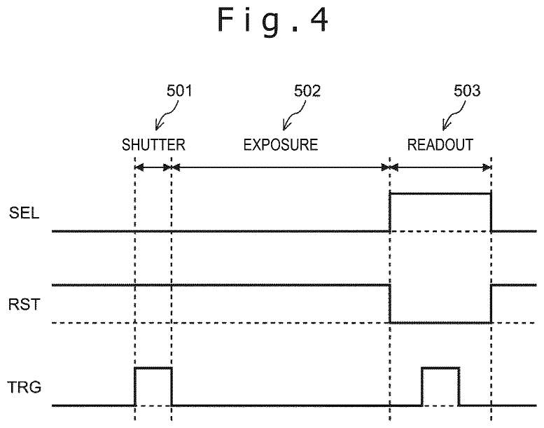

FIG. 4 is a diagram depicting an example of generation of the gradation signal. The drawing is a timing chart representing an example of generation of the gradation signal in the gradation signal generation section 110. In the drawing, “SEL” represents a selection signal transmitted by the signal line SEL. “RST” represents a reset signal transmitted by the signal line RST. “TRG” represents a transfer signal transmitted by the signal line TRG. The portion of a value “1” of a binarized waveform in these control signals represents an ON signal, which is a signal for conducting the MOS transistor. Note that a dashed line in the drawing represents a level of 0 V. As indicated in the drawing, the gradation signal is generated by a shutter 501, an exposure 502, and a readout 503. Note that, in an initial state, the selection signal, the reset signal, and the transfer signal have values of “0”, “1”, and “0”, respectively.

The shutter 501 is a period corresponding to an electronic shutter, during which the reset signal and transfer signal have a value of “1” and the MOS transistors 211 and 212 are conductive. As a result, the charges of the photoelectric conversion section 201 and the charge holding section 203 are discharged and reset.

The exposure 502 is a period in which the transfer signal has a value of “0 ” and the charge generated by the photoelectric conversion of the photoelectric conversion section 201 is accumulated in the photoelectric conversion section 201.

The readout 503 is a period in which the selection signal has a value of “1”, the reset signal has a value of “0”, and readout is performed in which the gradation signal generated by the MOS transistor 111 is output to the signal line 12. During this period, the transfer signal has a value of “1”, and the charges of the photoelectric conversion section 201 are transferred to the charge holding section 203. The MOS transistor 111 generates a gradation signal corresponding to the charge of the charge holding section 203 and outputs the gradation signal to the signal line 12.

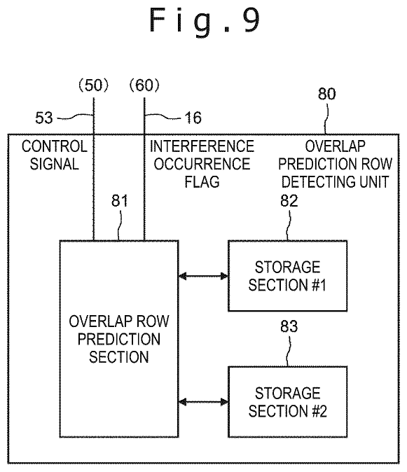

Thus, the gradation signal is generated in the three periods of the shutter 501, the exposure 502, and the readout 503, and output from the gradation signal generation section 110. As described above, the generation of the gradation signal is performed for each row. At this time, the shutter 501, the exposure 502, and the readout 503 are sequentially applied while shifting the timing for each row. This state will be described below with reference to FIG. 9.

### Configuration of Event Signal Generation Section

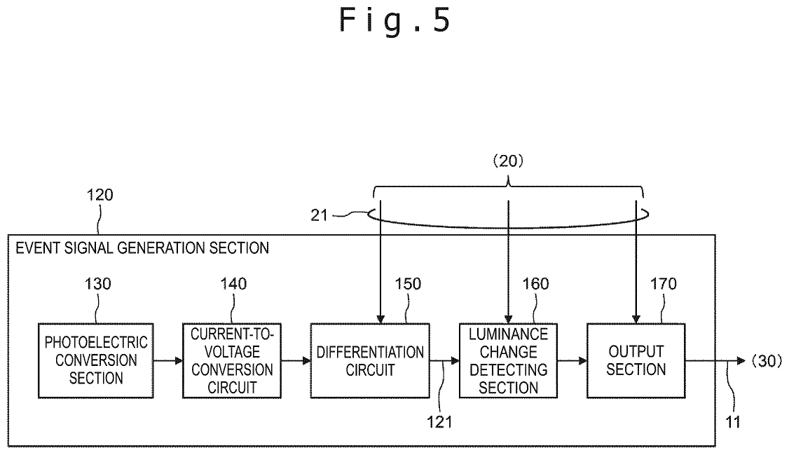

FIG. 5 is a diagram depicting a configuration example of the event signal generation section. The drawing is a block diagram depicting a configuration example of the event signal generation section 120. The event signal generation section 120 in the drawing includes a photoelectric conversion section 130, a current-to-voltage conversion circuit 140, a differentiation circuit 150, a luminance change detecting section 160, and an output section 170.

The photoelectric conversion section 130 photoelectrically converts incident light, similarly to the photoelectric conversion section 201. The photoelectric conversion section 130 can be constituted of a photodiode.

The current-to-voltage conversion circuit 140 converts the photocurrent from the photoelectric conversion section 130 into a voltage signal. In this conversion, the current-to-voltage conversion circuit 140 logarithmically compresses the voltage signal. The voltage signal after the conversion is output to the differentiation circuit 150. The configuration of the current-to-voltage conversion circuit 140 will be described in detail below.

The differentiation circuit 150 extracts a change in the voltage signal output from the current-to-voltage conversion circuit 140 and integrates the extracted change to generate a signal corresponding to a change amount in the voltage signal. This signal corresponds to a signal corresponding to a change in the luminance of the incident light. This signal is referred to as an optical signal. The differentiation circuit 150 outputs the generated optical signal to the luminance change detecting section 160 via a signal line 121. Further, the differentiation circuit 150 receives a control signal from the access control circuit 20. This control signal is a signal for resetting the circuit for detecting the change amount in the voltage signal described above. The configuration of the differentiation circuit 150 will be described in detail below.

The luminance change detecting section 160 detects a luminance change in the incident light. The luminance change detecting section 160 in the drawing detects a change in the optical signal output from the differentiation circuit 150 on the basis of a threshold. That is, in a case in which the change in the optical signal exceeds a threshold, the change in the optical signal is detected as an event. Here, an event in a direction in which the optical signal increases is referred to as an on-event, and an event in a direction in which the optical signal decreases is referred to as an off-event. The luminance change detecting section 160 detects an on-event and an off-event, respectively, by using the voltages of an on-event detection signal and an off-event detection signal supplied from the access control circuit 20 as thresholds. This detection result is output to the output section 170. The configuration of the luminance change detecting section 160 will be described in detail below.

The output section 170 outputs, as event signals, the on-event and the off-event detected by the luminance change detecting section 160 on the basis of the control signal from the access control circuit 20.

### Circuit Configuration of Event Signal Generation Section

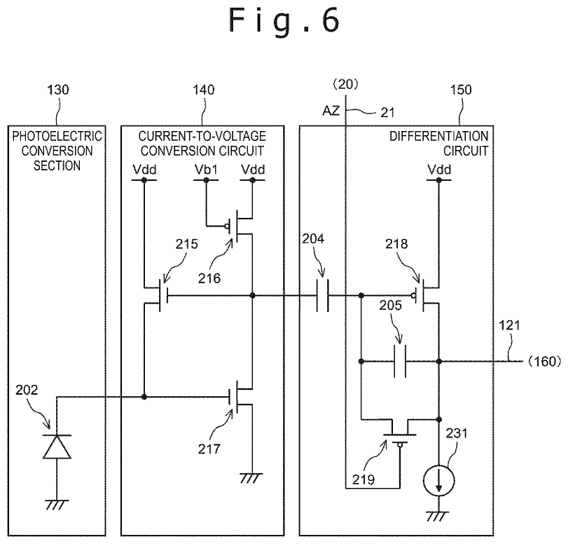

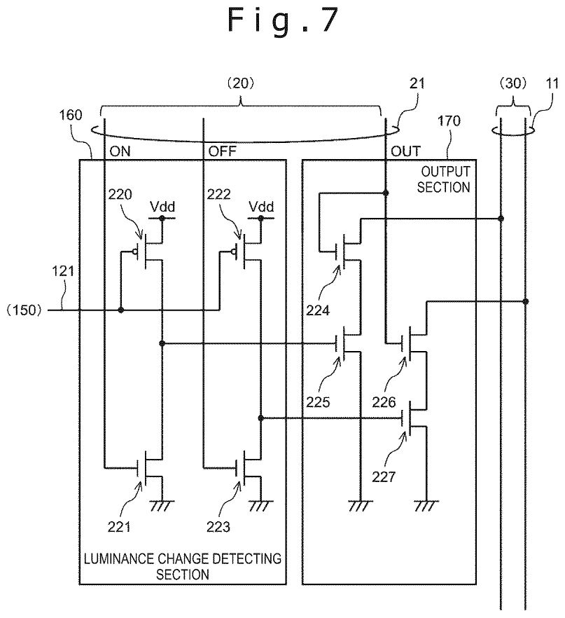

FIG. 6 and FIG. 7 are circuit diagrams depicting a configuration example of the event signal generation section. FIG. 6 is a circuit diagram depicting a configuration example of the current-to-voltage conversion circuit 140 and the differentiation circuit 150. Note that a photoelectric conversion section 202 is further depicted in the drawing. FIG. 7 is a circuit diagram depicting a configuration example of the luminance change detecting section 160 and the output section 170.

The current-to-voltage conversion circuit 140 in the drawing includes MOS transistors 215 to 217. In the drawing, Vdd represents the power supply line Vdd for supplying power. Vb1 represents a signal line Vb1 for supplying a bias voltage. As the MOS transistors 215 and 217, n-channel MOS transistors can be used. As the MOS transistor 216, a p-channel MOS transistor can be used.

An anode of the photoelectric conversion section 202 is grounded, and a cathode of the photoelectric conversion section 202 is connected to a source of the MOS transistor 215 and a gate of the MOS transistor 217. Sources of the MOS transistor 215 and the MOS transistor 216 are connected to the power supply line Vdd, and a gate of the MOS transistor 216 is connected to the signal line Vb1. A source of the MOS transistor 217 is grounded, a drain of the MOS transistor 217 is connected to a gate of the MOS transistor 215, a drain of the MOS transistor 216, and an output signal line of the current-to-voltage conversion circuit 140. One end of a capacitor of the differentiation circuit 150 is connected to this output signal line.

The MOS transistor 215 is a MOS transistor that supplies a current to the photoelectric conversion section 202. A sink current (photocurrent) corresponding to the incident light flows through the photoelectric conversion section 202. The MOS transistor 215 supplies this sink current. At this time, the gate of the MOS transistor 215 is driven by an output voltage of the MOS transistor 217 described below, and the MOS transistor 215 outputs a source current equal to a sink current of the photoelectric conversion section 202. A gate-source voltage Vgs of the MOS transistor is a voltage corresponding to the source current, and thus a source voltage of the MOS transistor 215 becomes a voltage corresponding to the current of the photoelectric conversion section 202. As a result, a photocurrent of the photoelectric conversion section 202 is converted into a voltage signal.

The MOS transistor 217 is a MOS transistor that amplifies the source voltage of the MOS transistor 215. The MOS transistor 216 constitutes a constant current load of the MOS transistor 217. The amplified voltage signal is output to the drain of the MOS transistor 217. This voltage signal is output to the differentiation circuit 150 and returned to the gate of the MOS transistor 215. In a case in which the Vgs of the MOS transistor 215 is equal to or lower than a threshold voltage, the source current changes in the form of an exponential function with respect to the change in Vgs. Therefore, the output voltage of the MOS transistor 217 returned to the gate of the MOS transistor 215 is a voltage signal obtained by logarithmically compressing the photocurrent of the photoelectric conversion section 202 equal to the source current of the MOS transistor 215.

### Configuration of Differentiation Circuit

The differentiation circuit 150 in the drawing includes capacitors 204 and 205, MOS transistors 218 and 219, and a constant current circuit 231. As the MOS transistors 218 and 219, p-channel MOS transistors can be used.

As described above, an output of the current-to-voltage conversion circuit 140 is connected to one end of the capacitor 204, and the other end of the capacitor 204 is connected to a gate of the MOS transistor 218, a drain of the MOS transistor 219, and one end of the capacitor 205. The other end of the capacitor 205 is connected to a drain of the MOS transistor 218, the drain of the MOS transistor 219, a sink-side terminal of the constant current circuit 231, and the signal line 121. A source of the MOS transistor 218 is connected to the power supply line Vdd, and a gate of the MOS transistor 219 is connected to a signal line AZ. The sink-side terminal of the constant current circuit 231 is grounded.

The capacitor 204 corresponds to a coupling capacitor. The capacitor 204 blocks a direct current component of the output voltage of the current-to-voltage conversion circuit 140 and passes only an alternating current component. Further, a current based on a change in the output voltage of the current-to-voltage conversion circuit 140 is supplied to the gate of the MOS transistor 218 via the capacitor 204. The alternating current component of the output voltage of the current-to-voltage conversion circuit 140 corresponds to the change in the photocurrent.

The MOS transistor 218 and the constant current circuit 231 constitute an inverting amplifier circuit. The change in the output voltage of the current-to-voltage conversion circuit 140 is input to the gate of the MOS transistor 218 via the capacitor 204, inverted and amplified by the MOS transistor 218, and output to the drain of the MOS transistor 218. Therefore, a current based on the change in the output voltage of the current-to-voltage conversion circuit 140 flows to the capacitor 205, and the capacitor 205 is charged and discharged. That is, the change in the output voltage of the current-to-voltage conversion circuit 140 is accumulated (integrated). An optical signal that is a signal corresponding to the change amount in the voltage signal output from the current-to-voltage conversion circuit 140 is output to the signal line 121.

The MOS transistor 219 resets the differentiation circuit 150. This MOS transistor 219 is made conductive, short-circuiting both ends of the capacitor 205. The integrated change in the output voltage of the current-to-voltage conversion circuit 140 is discharged and reset. By this reset, the output voltage of the differentiation circuit 150 becomes, for example, a voltage at a midpoint between the power supply line Vdd and the ground line. This reset is controlled by the AZ control signal transmitted through the signal line AZ. Hereinafter, the reset of the differentiation circuit 150 is referred to as an AZ operation.

### Configuration of Luminance Change Detecting Section

In FIG. 7, the luminance change detecting section 160 includes MOS transistors 220 to 223. As the MOS transistors 220 and 222, p-channel MOS transistors can be used. As the MOS transistors 221 and 223, n-channel MOS transistors can be used. Signal lines ON and OFF from the access control circuit 20 are connected to the luminance change detecting section 160. The signal line ON is a signal line for transmitting an on-event detection signal. The signal line OFF is a signal line for transmitting an off-event detection signal.

The signal line 121 is connected to a gate of the MOS transistor 220 and a gate of the MOS transistor 222. A source of the MOS transistor 220 is connected to the power supply line Vdd, and a drain of the MOS transistor 220 is connected to a drain of the MOS transistor 221 and a gate of a MOS transistor 225 of the output section 170. A gate of the MOS transistor 221 is connected to the signal line ON, and a source of the MOS transistor 221 is grounded. A source of the MOS transistor 222 is connected to the power supply line Vdd, and a drain of the MOS transistor 222 is connected to a drain of the MOS transistor 223 and a gate of a MOS transistor 227 of the output section 170. A gate of the MOS transistor 223 is connected to the signal line OFF, and a source of the MOS transistor 223 is grounded.

The circuit of the MOS transistors 220 and 221 constitutes a comparison circuit. An output of this comparison circuit changes in accordance with a magnitude relationship between a drain current on the sink side of the MOS transistor 221 and a drain current on the source side of the MOS transistor 220. In a case in which the output voltage of the differentiation circuit 150 is lower than a threshold based on the voltage of the on-event detection signal, specifically, a voltage obtained by subtracting the threshold voltage from the power supply voltage Vdd, a source current of the MOS transistor 220 is less than a sink current of the MOS transistor 221.

As a result, the output voltage is at an L level. On the other hand, in a case in which the output voltage of the differentiation circuit 150 is higher than the threshold voltage (voltage obtained by subtracting the threshold voltage from the power supply voltage Vdd), the sink current of the MOS transistor 221 is less than the source current of the MOS transistor 220. As a result, the output voltage transitions to an H level.

Thus, the comparison circuit constituted by the MOS transistors 220 and 221 compares the output voltage of the differentiation circuit 150 and the threshold voltage of the on-event detection signal, and detects an on-event that is a change in the direction in which the luminance of the incident light increases. Note that, in a case in which the on-event detection signal is a voltage higher than the threshold voltage, such as, for example, the power supply voltage of the power supply line Vdd, the output of the comparator is always at the L level. That is, by applying the threshold voltage as the on-event detection signal, it is possible to detect the on-event.

The circuit of the MOS transistors 222 and 223 also constitutes a comparison circuit. In a case in which the output voltage of the differentiation circuit 150 is lower than a threshold based on the voltage of the off-event detection signal, specifically, a voltage obtained by subtracting the threshold voltage from the power supply voltage Vdd, the output voltage is at the L level. On the other hand, in a case in which the output voltage of the differentiation circuit 150 is higher than the threshold voltage (voltage obtained by subtracting the threshold voltage from the power supply voltage Vdd), the output voltage transitions to the H level.

With the threshold of the off-event detection signal set to a voltage lower than the threshold of the on-event detection signal, the comparison circuit of the MOS transistors 222 and 223 detects an off-event that is a change in the direction in which the luminance of the incident light decreases. Note that, in a case in which the off-event detection signal is a voltage lower than the threshold voltage, such as, for example, the ground potential, the output of the comparator is always at the H level. That is, by applying the threshold voltage as the off-event detection signal, it is possible to detect the off-event.

### Configuration of Output Section

The output section 170 includes MOS transistors 224 to 227. As the MOS transistors 224 to 227, n-channel MOS transistors can be used. A drain of the MOS transistor 224 is connected to one of the signal lines 11, and a drain of the MOS transistor 226 is connected to the other of the signal lines 11. Gates of the MOS transistors 224 and 226 are commonly connected to a signal line OUT. A source of the MOS transistor 224 is connected to a drain of the MOS transistor 225, and a source of the MOS transistor 225 is grounded. A source of the MOS transistor 226 is connected to a drain of the MOS transistor 227, and a source of the MOS transistor 227 is grounded.

When an event readout signal is input to the signal line OUT, the MOS transistors 224 and 226 become conductive. As a result, drain voltages of the MOS transistors 225 and 227 are output to the signal lines 11. Since the on-event detection signal and the off-event detection signal of the luminance change detecting section 160 are applied to the gates of the MOS transistors 225 and 227, event signals including an on-event signal and an off-event signal are output to the signal lines 11.

In this way, the gradation signal generation section 110 and the event signal generation section 120 generate the gradation signal and the event signal, respectively. When the gradation signal is generated, the timing control unit 50 generates a gradation address signal that is an address signal of a row at which the gradation signal is to be generated, and outputs the gradation address signal to the access control circuit 20.

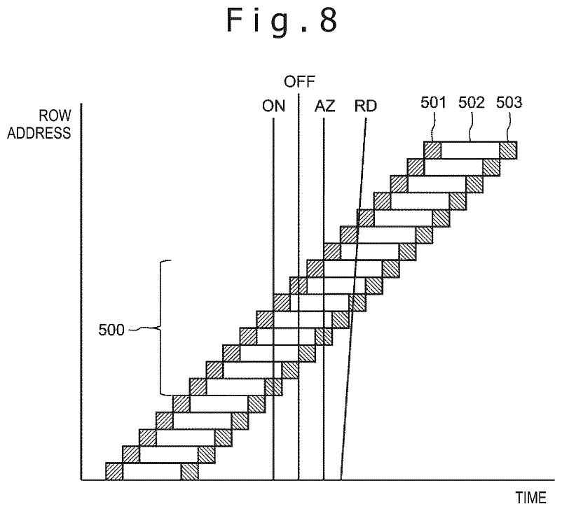

The access control circuit 20 outputs a selection signal, a reset signal, and a transfer signal to the pixels 100 in the row based on the gradation address signal. On the other hand, when an event signal is generated, the timing control unit 50 outputs, to the access control circuit 20, an on-event detection signal, an off-event detection signal, an AZ control signal, an output signal, and an event-based vision sensor (EVS) address signal that is an address signal for reading out an event signal. The access control circuit 20 sequentially outputs an on-event detection signal, an off-event detection signal, and an AZ control signal to all pixels 100 of the pixel array section 10. Subsequently, the output signals are sequentially output for each row of the pixel array section 10, and output (readout) of event signals is performed. This state will be described with reference to FIG. 8.

Note that the pixel 100 in FIG. 2 represents an example in which the gradation signal generation section 110 and the event signal generation section 120 each include a photoelectric conversion section. In contrast, the pixel 100 can be constituted in a form in which one photoelectric conversion section is shared by the gradation signal generation section 110 and the event signal generation section 120.

### Generation of Gradation Signal and Event Signal

FIG. 8 is a diagram depicting an example of generation of the gradation signal and the event signal. The drawing is a timing chart depicting an example of generation of the gradation signal and the event signal. In the drawing, the horizontal axis represents time, and the vertical axis represents row address. Note that the drawing represents an example of a case where a gradation signal during a frame period, which is a period in which the gradation signal for all rows of the pixel array section 10 is generated, is generated, and an event signal is generated during that period.

Rectangles in the drawing represent the periods of the shutter 501, the exposure 502, and the readout 503 described with reference to FIG. 4. As depicted in the drawing, the shutter 501, the exposure 502, and the readout 503 are sequentially executed while shifting the timing for each row, thereby generating the gradation signal of one frame. Such a method of generating a gradation signal is referred to as a rolling shutter method.

Solid lines in the drawing represent the timing of on-event detection (“ON” in the drawing), off-event detection (“OFF” in the drawing), AZ operation (“AZ” in the drawing), and event signal output (readout; “RD” in the drawing). As depicted in the drawing, the on-event detection, the off-event detection, and the AZ operation are each performed simultaneously for the pixels 100 of all rows.

Therefore, overlap occurs between the rows in which the gradation signal is generated and the rows in which the on-event detection, the off-event detection, and the AZ operation are performed. In the pixels 100 in such rows, the interference described above occurs. Here, overlap prediction rows are detected, which are rows where overlap between the period in which the gradation signal is generated and the period in which events are detected (for example, periods from on-event detection and off-event detection to AZ operation) is predicted. In the drawing, overlap prediction rows 500 are illustrated.

### Configuration of Overlap Prediction Row Detecting Unit

FIG. 9 is a diagram depicting a configuration example of the overlap prediction row detecting unit. The drawing is a block diagram depicting a configuration example of the overlap prediction row detecting unit 80. The overlap prediction row detecting unit 80 in the drawing includes an overlap row prediction section 81, a storage section (#1) 82, and a storage section (#2) 83.

The overlap row prediction section 81 detects overlap prediction rows on the basis of control signals from the timing control unit 50. The gradation address signal, the on-event detection signal, the off-event detection signal, the AZ control signal, the output signal, and the EVS address signal are input to the overlap row prediction section 81. The overlap row prediction section 81 detects the overlap prediction rows from these control signals. For example, the overlap prediction rows can be detected from the gradation address signal when the on-event detection signal, the off-event detection signal, and the AZ control signal are input. In this case, an error due to interference occurs in either the gradation signal or the event signal.

The overlap row prediction section 81 can also detect the overlap prediction rows from the gradation address signal and the EVS address signal. In this case, the overlap prediction rows can be detected before generation of the event signal or the like, making it possible to reduce the effects of interference by avoiding generation of the gradation signal and generation of the event signal in the overlap prediction rows.

The overlap row prediction section 81 stores information related to the overlap prediction rows detected from the on-event detection signal, the off-event detection signal, and the gradation address signal in the storage section (#1) 82. The overlap row prediction section 81 generates an interference occurrence flag based on the information related to the detected overlap prediction rows, and outputs the interference occurrence flag to the event signal processing unit 60.

The overlap row prediction section 81 stores information related to the overlap prediction rows detected from the AZ control signal and the gradation address signal in the storage section (#2) 83. In a case in which the AZ operation is affected by the interference, the effects appear in the event signal in the next frame period. Here, the information related to the overlap prediction rows in this case is held in the storage section (#2) 83, which differs from the storage section (#1) 82. When the frame period transitions to the next frame period, the overlap row prediction section 81 generates an interference occurrence flag based on the information related to the overlap prediction rows stored in the storage section (#2) 83, and outputs the interference occurrence flag to the event signal processing unit 60.

### Event Data

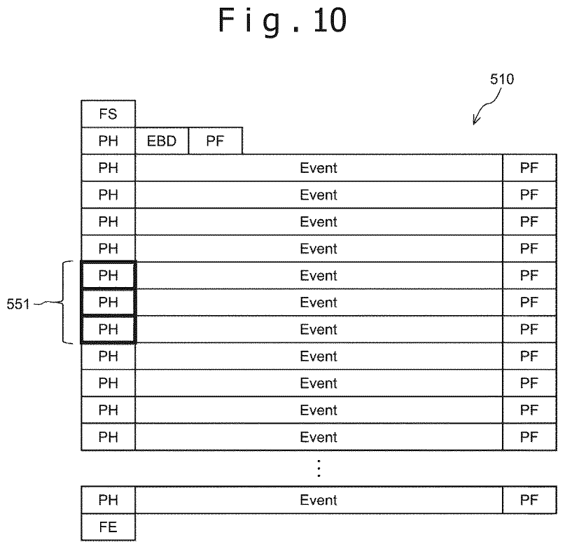

FIG. 10 is a diagram depicting an example of event data. The drawing is a diagram depicting an example of the event data generated by the event signal processing unit 60. The drawing depicts a frame 510 of event data in one frame period. In the drawing, “FS” is a block indicating the start of a frame. “FE” is a block indicating the end of the frame. “PH” is a block indicating a header of a packet. “PF” is a block indicating a footer of a packet. “EBD” is a block indicating embedded data. “Event” is a block in which an event signal for each row is held. This “Event” is disposed between “PH” and “PF”. Note that a region 551 in the drawing represents a region of data of rows corresponding to the overlap prediction rows 500.

In the drawing, an event signal affected by the interference is stored in an “Event” corresponding to the region 551. Here, an interference occurrence flag is added to “PH” of the “Event”. A bold rectangle in the drawing represents a “PH” to which the interference occurrence flag is added. This makes it possible to identify data affected by the interference. The identified data can be removed in a device that uses the event data. The event signal processing unit 60 adds mask information to the “PH” of a row based on the interference occurrence flag output from the overlap prediction row detecting unit 80, for example. Note that the interference occurrence flag can be disposed on the “PF” side. Note that the interference occurrence flag is an example of information indicating an overlap prediction row.

### Overlap Row Detection Processing

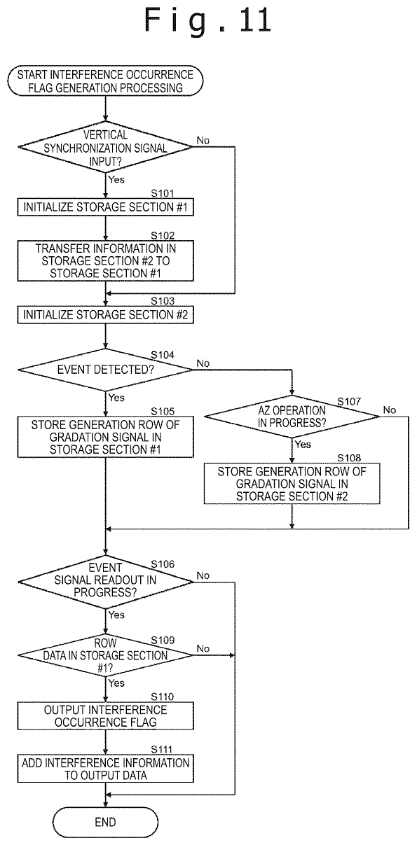

FIG. 11 is a diagram depicting an example of a processing procedure of overlap row detection processing. First, the overlap row prediction section 81 determines whether a vertical synchronization signal indicating the start of a frame period has been input (step S100). When the vertical synchronization signal has not been input (step S110, No), the overlap row prediction section 81 proceeds to the processing of step S103. On the other hand, when the vertical synchronization signal has been input (step S100, Yes), the overlap row prediction section 81 initializes the storage section (#1) 82 (step S101). Subsequently, the overlap row prediction section 81 transfers the information stored in the storage section (#2) to the storage section (#1) (step S102), and proceeds to the processing of step S103. In step S103, the overlap row prediction section 81 initializes the storage section (#2) 83 (step S103).

Subsequently, the overlap row prediction section 81 determines whether an event is being detected (step S104). When an event is being detected (step S104, Yes), the overlap row prediction section 81 stores the row in which the gradation signal is to be generated in the storage section (#1) 82 (step S105), and proceeds to the processing of step S106. On the other hand, when an event is not being detected (step S104, No), the overlap row prediction section 81 determines whether an AZ operation is in progress (step S107). When an AZ operation is not in progress (step S107, No), the overlap row prediction section 81 proceeds to the processing of step S106. On the other hand, when an AZ operation is in progress (step S107, Yes), the overlap row prediction section 81 stores the row in which the gradation signal is to be generated in the storage section (#2) 82 (step S108), and proceeds to the processing of step S106.

In step S106, the overlap row prediction section 81 determines whether an event signal is being read out (step S106). When the event signal is not being read out (step S106, No), the overlap row prediction section 81 ends the processing. On the other hand, when the event signal is being read out (step S106, Yes), the overlap row prediction section 81 determines whether data of the row is stored in the storage section (#1) 82 (step S109). When data of the row is not stored in the storage section (#1) 82 (step S109, No), the overlap row prediction section 81 ends the processing.

On the other hand, when data of the row is stored in the storage section (#1) 82 (step S109, Yes), the overlap row prediction section 81 outputs an interference occurrence flag to the event signal processing unit 60 (step S110). Subsequently, the event signal processing unit 60 adds the interference information to the output data (step S111).

Thus, the light detection device 1 detects overlap prediction rows which are rows in which an overlap between the period in which the gradation signal is generated and the period in which the event is detected is predicted, and adds information indicating the occurrence of interference to the event data including the event signal of the rows. This makes it possible to avoid using an event signal affected by the interference, and reduce the effects of the interference.

### Configuration Related to Correction

By the processing described above, it is possible to detect event data that may be affected by interference and output an interference occurrence flag. For example, by correcting the event data for which an interference occurrence flag is output, it is possible to reduce the effects of the interference and improve the accuracy of the event data.

There is also the possibility that event data for which an interference occurrence flag is output is uniformly corrected. In this case, the same correction is then performed for event data having a high interference intensity and event data having a low interference intensity. This leads to the possibility of inappropriate correction, with event data having a high interference intensity being weakly corrected and event data having a low interference intensity being strongly corrected. Here, description will be made of a case in which appropriate correction can be performed by performing correction according to the interference intensity.

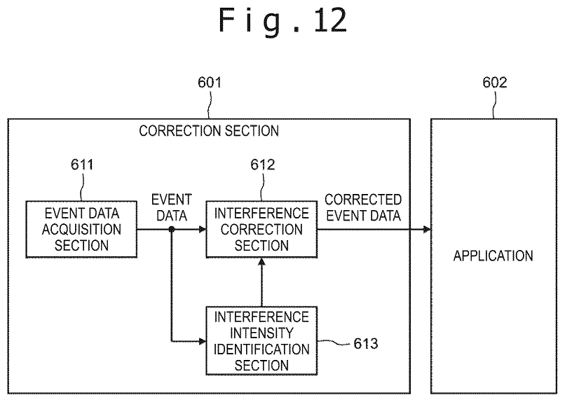

FIG. 12 is a diagram depicting a configuration example of a correction section 601 that performs correction according to interference intensity. The correction section 601 depicted in FIG. 12 is configured to include an event data acquisition section 611, an interference correction section 621, and an interference intensity identification section 613. The correction section 601 depicted in FIG. 12 is provided in a sensor, such as, for example, in the light detection device 1 (FIG. 1). A configuration can be adopted in which the correction section 601 is provided in the event signal processing unit 60 (FIG. 1), or is provided outside the event signal processing unit 60 and provided at a position where the event data from the event signal processing unit 60 is processed.

The event data acquisition section 611 of the correction section 601 acquires event data and supplies the acquired event data to the interference correction section 612 and the interference intensity identification section 613. The interference correction section 612 corrects the event data on the basis of information related to the interference intensity supplied from the interference intensity identification section 613, and outputs the corrected event data to, for example, an application 602 in a subsequent stage.

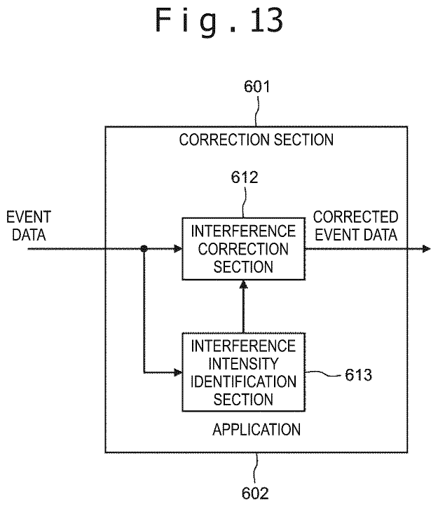

FIG. 13 is a diagram depicting another configuration example of the correction section 601 that performs correction according to the interference intensity. A configuration may be adopted in which the correction section 601 is provided in the application (application processor) 602. In this case, for example, both or one of the interference correction section 612 and the interference intensity identification section 613 is provided in the application 602 that acquires and processes the event data output from the event signal processing unit 60 (FIG. 1).

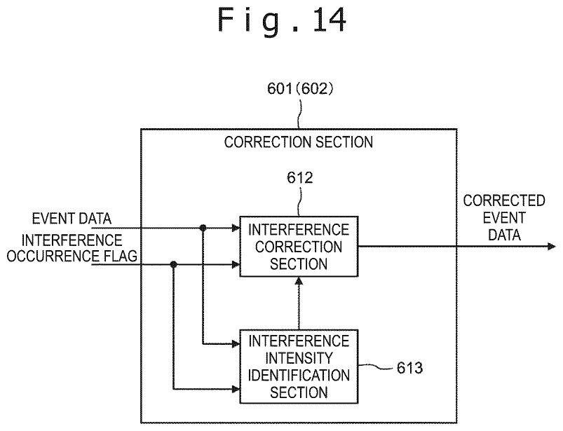

FIG. 14 is a diagram depicting yet another configuration example of the correction section 601 that performs correction according to the interference intensity. The correction section 601 depicted in FIG. 14 differs from the correction section 601 depicted in FIG. 13 in that the event data and the interference occurrence flag are input to the interference correction section 612, and other aspects have similar configurations. In a case in which the correction section 601 depicted in FIG. 14 is provided, for example, in the light detection device 1 (FIG. 1), a configuration including the event data acquisition 611 can be adopted. The correction section 601 depicted in FIG. 14 may be provided in a sensor or may be provided in the application processor 602 outside the sensor.

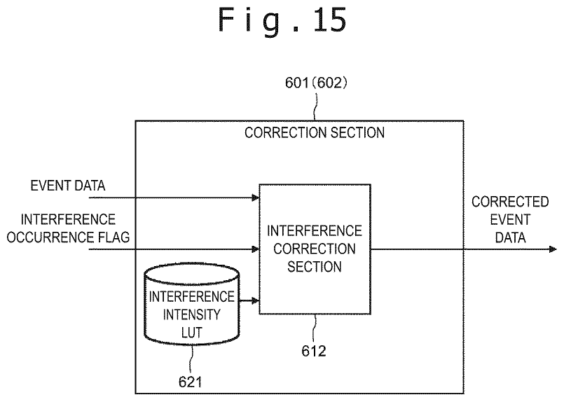

FIG. 15 is a diagram depicting yet another configuration example of the correction section 601 that performs correction according to the interference intensity. The correction section 601 depicted in FIG. 15 is similar to the correction section 601 depicted in FIG. 14 in that the event data and the interference occurrence flag are input to the interference correction section 612, but differs in that an interference intensity lookup table (LTU) 321 is provided.

The correction section 601 depicted in FIG. 15 may be provided in a sensor or may be provided in the application processor 602 outside the sensor. As described below, the interference intensity LUT 621 is a table associating predetermined rows in one frame and interference intensities, and the interference correction section 612 refers to the interference intensity LUT 621 and performs correction according to the interference intensity.

In the case of a configuration in which the interference intensity LUT 621 is provided, it is possible to adopt a configuration in which the interference occurrence flag is not input, or a configuration in which the interference occurrence flag is not generated, and a portion related to the generation of the interference occurrence flag is omitted. In other words, the interference intensity LUT 621 can include the interference occurrence flag, that is, information related to the pixel where the interference occurs, making it possible to omit the processing and functions related to the interference occurrence flag.

### Event Data Before Correction and After Correction

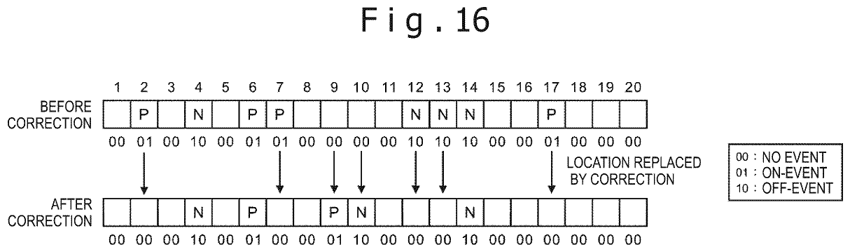

The event data before correction and the event data after correction will now be described with reference to FIG. 16. The upper portion of FIG. 16 depicts an example of the event data in a predetermined row before correction, and the lower portion of FIG. 16 depicts an example of the event data in a predetermined row after correction.

In FIG. 16, one square represents one pixel (one event signal generation section 120). P indicates that the event data is event data of an on-event, and the event data is represented by “01”. N indicates that the event data is event data of an off-event, and the event data is represented by “10”. A blank field indicates that there is no event, and the event data is represented by “00”. Numbers 1 to 20 indicated in the upper portion of the drawing are numbers given for the sake of explanation.

Pixel 1 has no event, and the event data is “00”. Pixel 2 has an on-event, and the event data is “01”. Pixel 3 has no event, and the event data is “00”. Pixel 4 has an off-event, and the event data is “10”. Pixel 5 has no event, and the event data is “00”. Pixels 6 and 7 have on-events, and the event data is “01”.

Pixels 8 to 11 have no event, and the event data is “00”. Pixels 12 to 14 have off-events, and the event data is “10”. Pixels 15 and 16 have no events, and the event data is “00”. Pixel 17 has an on-event, and the event data is “01”. Pixels 18 to 20 have no events, and the event data is “00”.

When the correction section 601 acquires such event data, the interference correction section 612 performs correction according to the interference intensity, and outputs the event data after the correction, such as depicted in the lower portion of FIG. 16, for which details will be described below. Description will now be made of locations where the event data is replaced by correction.

The pixel 2, the pixel 7, and the pixel 17 have event data of on-events, but are corrected to data of “00” indicating no event by correction. The pixels 12 and 13 have event data of off-events, but are corrected to data of “00” indicating no event by correction. Thus, by the correction of a pixel in which an on-event or an off-event has occurred, the pixel may be corrected to a pixel without an event.

The pixel 9 has event data of no event, but is corrected to event data “01” indicating an on-event by correction. The pixel 10 has event data of no event, but is corrected to data of event data “10” indicating an off-event by correction. Thus, by the correction of a pixel detected as having no event, the pixel may be corrected to a pixel in which an on-event or an off-event has occurred.

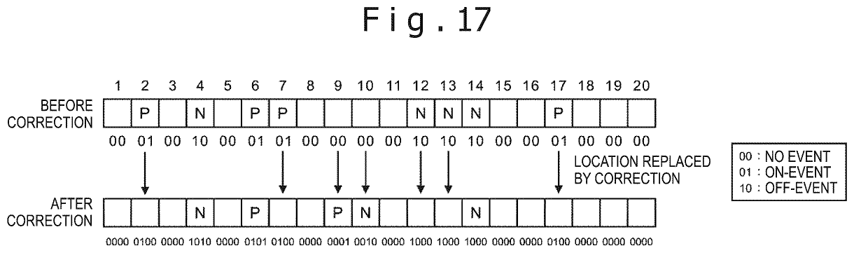

A data string such as depicted in the lower portion of FIG. 16 is output to a subsequent stage as corrected event data. In this case, the event data before correction for one pixel is represented by two bits, and the event data after correction is also represented by two bits. As depicted in FIG. 17, the 2-bit event data before correction may be converted, by correction, into 4-bit event data and output as 4-bit event data to a subsequent stage.

The upper portion of FIG. 17 is the same as the event data before correction depicted in the upper portion of FIG. 16, and represents the event data before correction input to the interference correction section 612. The pixel 1, the pixel 3, the pixel 5, the pixel 8, the pixel 11, the pixel 15, the pixel 16, and the pixels 18 to 20 have event data of no event, and have event data of no event even after correction.

These pixels have the same event data before and after correction, and are pixels treated as having event data that does not need to be corrected, or are pixels with the same event data as a result of the correction. In such a case, the 2-bit event data “00” after correction is concatenated to the 2-bit event data “00” before correction, in other words, the event data before correction is converted into the 4-bit event data “0000” that repeats the event data before correction twice, and the event data after this conversion is output to a subsequent stage as corrected event data.

The pixel 4 and the pixel 14 have event data of off-events, and also have event data of off-events after correction. These pixels have the same event data before and after correction, and are pixels treated as having event data that does not need to be corrected, or are pixels with the same event data as a result of the correction.

In such a case, the 2-bit event data “10” after correction is concatenated to the 2-bit event data “10” before correction, in other words, the event data before correction is converted into the 4-bit event data “1010” that repeats the event data before correction twice, and the event data after this conversion is output to a subsequent stage as corrected event data.

The pixel 6 has event data of an on-event, and also has event data of an on-event after correction. This pixel has the same event data before and after the correction, and is a pixel treated as having event data that does not need to be corrected, or is a pixel with the same event data as a result of the correction.

In such a case, the 2-bit event data “01” after correction is concatenated to the 2-bit event data “01” before correction, in other words, the event data before correction is converted into the 4-bit event data “0101” that repeats the event data before correction twice, and the event data after this conversion is output to a subsequent stage as corrected event data.

The pixel 2, the pixel 7, and the pixel 17 have event data of on-events, but are pixels corrected to have event data of no event after correction. In such a case, the 2-bit event data “00” after correction is concatenated to the 2-bit event data “01” before correction and converted into 4-bit event data “0100”, and the event data after this conversion is output to a subsequent stage as corrected event data.

The pixel 12 and the pixel 13 have event data of off-events, but are pixels corrected to have event data of no event after correction. In such a case, the 2-bit event data “00” after correction is concatenated to the 2-bit event data “10” before correction and is converted into the 4-bit event data “1000”, and the event data after this conversion is output to a subsequent stage as corrected event data.

The pixel 9 has event data of no event, but is a pixel corrected to have event data of an on-event after correction. In such a case, the 2-bit event data “01” after correction is concatenated to the 2-bit event data “00” before correction, and is converted into 4-bit event data “0001”, and the event data after this conversion is output to a subsequent stage as corrected event data.

The pixel 10 has event data with no event, but is a pixel corrected to have event data of an off-event after correction. In such a case, the 2-bit event data “10” after correction is concatenated to the 2-bit event data “00” before correction and is converted into 4-bit event data “0010”, and the event data after this conversion is output to a subsequent stage as corrected event data.

A data string such as depicted in the lower portion of FIG. 17 is output to a subsequent stage as corrected event data. For example, in a case in which the subsequent stage is the application 602, the application 602 may perform processing using the 4-bit event data after correction, or may perform processing using the 2-bit event data of the latter half (two bits added after correction processing).

In a case in which the 4-bit event data after correction is used, the application 602 can be configured to compare the 2 bits of the second half (event data after correction) with the 2 bits of the first half (event data before correction), and execute different processing depending on whether the bits are the same, that is, correction has not been performed, or the bits are different, that is, the correction has been performed.

### Processing of Correction Section

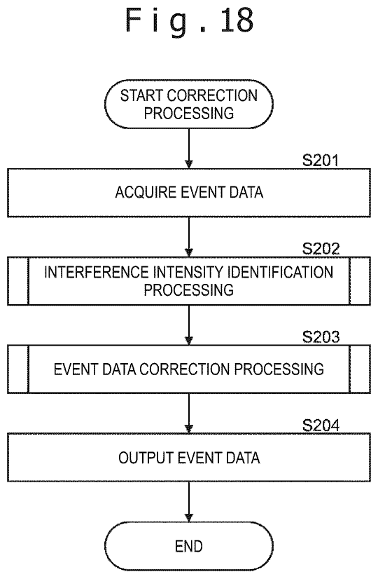

The processing of the correction section 601 will now be described with reference to the flowchart of FIG. 18. Here, description will continue by using the processing of the correction section 601 in the case of the configuration depicted in FIG. 12 as an example. The basic processing, however, can be similarly performed in the correction section 601 depicted in any of FIG. 13 to FIG. 15.

In step S201, the event data acquisition section 611 acquires the event data.

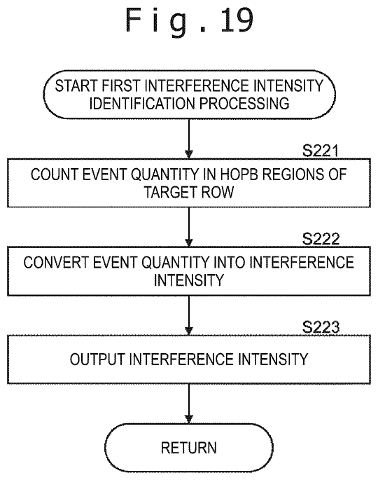

In step S202, the interference intensity identification section 613 identifies the interference intensity. The processing in step S202 will be described below with reference to FIG. 19 to FIG. 25.

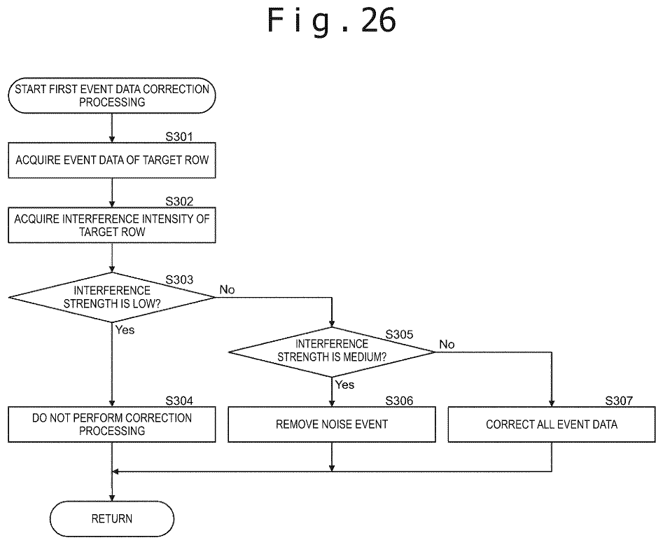

In step S203, the interference correction section 612 corrects the event data according to the interference intensity and generates corrected event data. The processing in step S203 will be described below with reference to FIG. 26 to FIG. 32.

In step S204, the corrected event data is output to a processing unit in a subsequent stage.

### First Interference Intensity Identification Processing

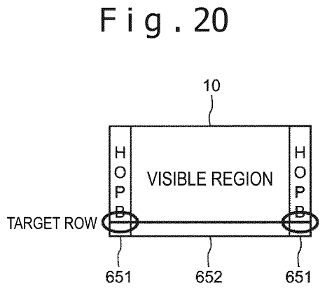

The interference intensity identification processing in step S202 will now be described with reference to the flowchart of FIG. 19. The processing based on the flowchart depicted in FIG. 19 is the interference intensity identification processing (referred to as first interference intensity identification processing) performed in the light detection device 1 including the pixel array section 10 including an optical black region as depicted in FIG. 20.

In step S221, an event quantity in a horizontal optical black (HOPB) region of a target row is counted. The HOPB region will be described with reference to FIG. 20. The pixel region of the pixel array section 10 is configured to include an effective pixel region 652 (“Visible” region in the drawing) that actually receives light, amplifies signal charges generated by photoelectric conversion, and reads out the signal charges to the column signal processing circuit, and HOPB regions 651 for outputting optical black serving as a reference of a black level.

FIG. 20 depicts an example in which optical black regions in a vertical direction (longitudinal direction in the drawing) are provided, and the regions are referred to as the HOPB regions 651. The optical black region may be provided in a horizontal direction as well. Although FIG. 20 depicts an example in which the HOPB regions 651 are provided on left and right sides, a configuration can be adopted in which the HOPB region 651 is provided only on the left side or only on the right side.

In step S221 (FIG. 19), the events occurring in the target row in the HOPB regions 651 are counted. The HOPB region 651 is a region where light is blocked, and is a region where there is no change in luminance and no event is expected to occur. In a case in which interference occurs, the possibility exists that an event occurs even in such a region. When the interference is highly generated, the event quantity in the HOPB region 651 also increases. The interference intensity is detected by utilizing this information.

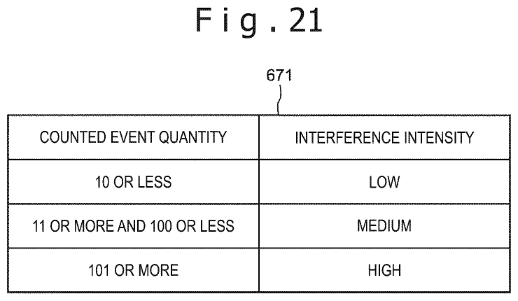

In step S221, events occurring in the HOPB regions 651 of a row (target row) to be measured for interference intensity are counted. In step S222, the event quantity counted is converted into an interference intensity. For example, a table such as depicted in FIG. 21 is provided, and the event quantity is converted into the interference intensity with reference to the table.

With reference to FIG. 21, a table 671 is a table associating the event quantity counted and the interference intensity. The table 671 depicted in FIG. 21 indicates a case in which the event data quantity in one row of the HOPB regions 651 is 500, for example. This is an example, and the event data quantity in the HOPB regions 651 may be set to a numerical value other than 500, and each numerical value described below may be a value other than the value indicated.

In a case in which the counted event quantity is “10 or less”, the interference intensity is converted to “low”. In a case in which the counted event quantity is “11 or more and 100 or less”, the interference intensity is converted to “medium”. In a case in which the counted event quantity is “101 or more”, the interference intensity is converted to “high”.

Note that a configuration other than the configuration in which the table 671 is provided and the event quantity is converted into interference intensity by referring to the table, such as, for example, a configuration in which the interference intensity is calculated from the event quantity using a predetermined calculation equation, may be adopted.

The event quantity may be counted separately for the on-event and the off-event, or may be counted collectively without distinguishing between the two.

The on-event and the off-event may be counted separately and the interference intensity of the on-event and the interference intensity of the off-event may be estimated separately, or the on-event and the off-event may be counted collectively without distinguishing between the two and the interference intensity may be estimated by using the count value obtained by the collective counting.

Although the interference intensity is classified herein into the three levels of high, medium, and low, in other words, the interference intensity is classified discretely, the interference intensity may be estimated and output as a continuous value, such as, for example, interference intensity =0.8.

In step S223, the interference intensity converted from the event quantity in step S222 is output from the interference intensity identification section 613 to the interference correction section 612.

Thus, in a case in which a light-shielded region is provided in the pixel array section 10, the interference intensity identification section 613 can be configured to identify the interference intensity by using the event data obtained from this light-shielded region.

### Second Interference Intensity Identification Processing

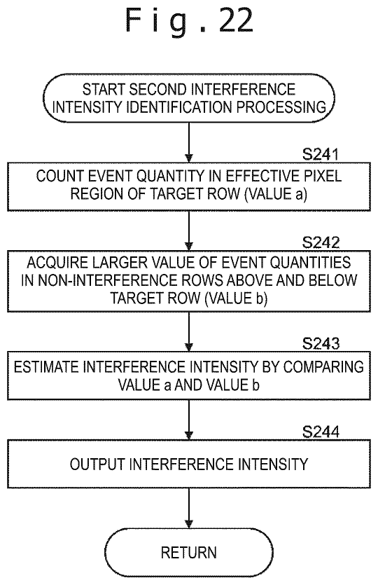

The interference intensity identification processing (referred to as second interference intensity identification processing) in step S202 will now be described with reference to the flowchart of FIG. 22.

The first interference intensity identification processing described with reference to FIG. 19 is described by using, as an example, processing of identifying the interference intensity by counting the event quantity by using the HOPB regions 651 of the pixel array section 10. The second interference intensity identification processing described with reference to FIG. 22 will be described by using, as an example, processing of identifying the interference intensity by counting the event quantity by using the effective pixel region 652 (FIG. 20) of the pixel array section 10.

In step S241, the event quantity occurring in the target row in the effective pixel region 652 is counted. The value of the counted event quantity is set as a value a.

In step S242, the larger value of the event quantity in non-interference rows above and below the target row is acquired. The acquired value is referred to as a value b. In step S242, the event quantity obtained from a row that is above the target row in the effective pixel region 652 and determined to be without interference and the event quantity obtained from a row that is below the target row in the effective pixel region 652 and determined to be without interference are acquired and compared, and the larger value is acquired as the value b.

Note that, herein, description will continue by using, as an example, a case in which the larger value of the event quantities in the non-interference rows above and below the target row is acquired and this larger value is used, but another value may be used. For example, an average value of the event quantities in the non-interference rows above and below the target row may be calculated, and this average value may be used.

Although a case in which the event quantities in the non-interference rows above and below the target row are used will be described as an example, a configuration can also be adopted in which either the event quantity in the non-interference row above the target row or the event quantity in the non-interference row below the target row is used.

In the effective pixel region 652, normal events also exist, in other words, events that occur in a normal state in which no interference is occurring exist, and thus, unlike the HOPB regions 651, the intensity of interference cannot be estimated by counting the event quantity alone, as in the HOPB regions 651. Here, the interference intensity of the target row is identified by comparing the event quantity in the target row with the event quantities in the non-interference rows above and below the target row, in other words, the event quantities in the rows in which events are normally detected. The interference intensity is estimated on the basis of the extent to which the event quantity in the target row is larger than the event quantities in the non-interference rows.

To perform such a comparison, in step S242, the value b which is the larger value of the event quantities in the non-interference rows above and below the target row is acquired. Whether the upper and lower rows are non-interference rows can be determined by using, for example, the interference occurrence flag. For example, the processing is performed by setting a row that is located above the target row and in which the interference occurrence flag is not set as an upper non-interference row and setting a row that is located below the target row and in which the interference occurrence flag is not set as a lower non-interference row.

A non-interference row is a row in which the interference occurrence flag is not set, and thus is not necessarily a row adjacent to the target row. For example, in a case in which the interference occurrence flag is set in the row immediately above the target row, the row is avoided and the determination is made as to whether the interference occurrence flag is set in the row thereabove. Further, in a case in which the interference occurrence flag is set, the processing of determining whether the interference occurrence flag is set in the row thereabove is repeated until a row determined that an interference occurrence flag is not set is reached.

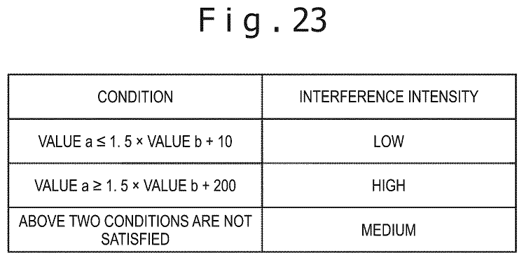

In step S243, the interference intensity is determined by comparing the value b with the value a. For example, it is possible to provide the conditions indicated in FIG. 23 and identify the interference intensity by confirming which condition is met. The conditions indicated in FIG. 23 are examples of conditions in a case in which the event data quantity in one row is 1920. The event data quantity in one row is not limited to 1920, and may be an event data quantity other than 1920. Further, conditions corresponding to event data quantities are set as appropriate. Numerical values of the conditions indicated in FIG. 23, such as, for example, the numerical values of 1.5, 10, and 200, are examples, are not descriptions indicating limitations, and can be set to appropriate values according to the event data quantities or the like, as appropriate.

With reference to FIG. 23, in a case in which the condition “a≤1.5×Value b+10” is satisfied, the interference intensity is estimated as “Low”. In a case in which the condition “Value a≥1.5×Value b+200” is satisfied, the interference intensity is estimated as “High”. In a case in which the condition “The above two conditions are not satisfied” is satisfied, the interference intensity is estimated as “Medium”.

The event quantity may be counted separately for the on-event and the off-event, or may be counted collectively without distinguishing between the two.

The on-event and the off-event may be counted separately and the interference intensity of the on-event and the interference intensity of the off-event may be estimated separately, or the on-event and the off-event may be counted collectively without distinguishing between the two and the interference intensity may be estimated by using the count obtained by the collective counting.

Although the interference intensity is classified herein into the three levels of high, medium, and low, in other words, the interference intensity is classified discretely, the interference intensity may be estimated and output as a continuous value, such as, for example, interference intensity=0.8. In this case, the conditions described above can be changed such that the interference intensity is obtained by a predetermined calculation equation in which the value a and the value b are substituted, for example.

Thus, a configuration can be adopted in which the interference intensity is identified by using the event data obtained from the effective pixel region 652 of the pixel array section 10.

### Third Interference Intensity Identification Processing

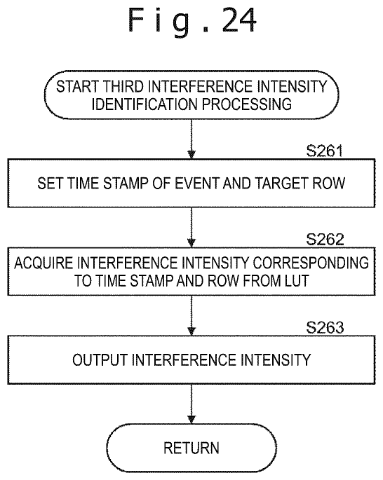

The interference intensity identification processing (referred to as third interference intensity identification processing) in step S202 will now be described with reference to the flowchart of FIG. 24.

The third interference intensity identification processing is performed in a case in which the correction section 601 includes the interference intensity LUT 621 as depicted in FIG. 15. In step S261, a time stamp of the event and the target row are set. The time stamp is information that can be handled similarly to the frame number, and is information for identifying a frame (information for identifying at which point in time a frame has been acquired). In step S261, a frame to be processed and a row (target row) for identifying the interference intensity in that frame are set.

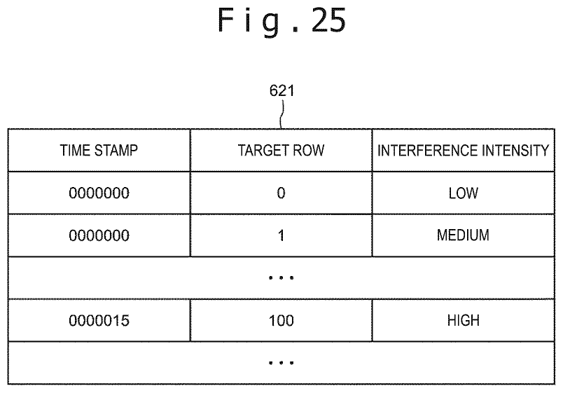

In step S262, the time stamp and the interference intensity corresponding to the target row are acquired from the interference intensity LUT 621. FIG. 25 is a diagram depicting an example of the interference intensity LUT 621. The interference intensity LUT 621 is a table associating time stamps, target rows, and interference intensities.

The interference intensity LUT 621 is a table associating time stamps, target rows, and interference intensities. In the interference intensity LUT 621 depicted in FIG. 25, “00000000”, “0”, and “Low” are associated with one another as the time stamp, the target row, and the interference intensity, respectively, and “00000000”, “1”, and “Medium” are associated with one another as the time stamp, the target row, and the interference intensity, respectively, for example. Further, in the interference intensity LUT 621 depicted in FIG. 25, “00000015”, “100”, and “High” are associated with one another as the time stamp, the target row, and the interference intensity, respectively, for example.

Such an interference intensity LUT 621 is created in a case in which, for example, a pattern of how the interference intensity transitions is obtained, and is provided in the correction section 601. The frames, rows, and the like in which interference is likely to occur may depend on the device, and the interference intensity LUT 621 can be created in a case in which there are similar patterns depending on the device.

In a case in which the transition of the interference intensity has periodicity, the LUT for one period needs only be stored in the interference intensity LUT 621. A mechanism may be provided in which the interference intensity LUT 621 is updated through learning by acquisition of the interference occurrence flag.

The table of the interference intensity LUT 621 can be configured such that a table is provided for each of the two types of events, that is, the on-event and the off-event. The table can be provided as a table in which the on-event and the off-event are collected without being distinguished from each other.

Although the interference intensity is classified herein into the three levels of high, medium, and low, in other words, the interference intensity is classified discretely, the interference intensity may be estimated as a continuous value, such as, for example, interference intensity=0.8, and the value of the continuous value may be entered in the interference intensity LUT 621.

In step S262, the interference intensity corresponding to the time stamp set as the frame subject to processing and the target row in step S261 is read out from the interference intensity LUT 621. In step S263, the interference intensity read out from the interference intensity LUT 621 is output from the interference intensity LUT 621 to the interference correction section 612.

Thus, in a case in which there is a specific pattern in the way of appearance of the interference intensity, it is possible to adopt a configuration in which the interference intensity LUT 621 is created in advance, and the interference intensity is identified with reference to the interference intensity LUT 621.

Returning to the flowchart of FIG. 18, in step S202, the interference intensity identification processing is executed. The interference intensity identification processing is performed by executing any one of the first to third interference intensity identification processing described above or by executing a combination thereof. When the interference intensity is identified by the interference intensity identification processing, the correction processing of the event data is executed in step S203.

### First Event Data Correction Processing

The event data correction processing executed in step S203 will now be further described. FIG. 26 is a flowchart for describing the first event data correction processing.

In step S301, the interference correction section 612 acquires the event data of the target row (row subject to processing) output from the event data acquisition section 611. In step S302, the interference correction section 612 acquires the interference intensity of the target row identified by the interference intensity identification section 613.

Herein, description will continue by using, as an example, a case in which the three types of interference intensities of low, medium, and high are identified as the interference intensities in the interference intensity identification section 613 and output to the interference correction section 612. The method for correcting the event data is switched according to the interference intensity. In step S303, the interference correction section 612 determines whether the interference intensity is low.

In a case in which the determination is made in step S303 that the interference intensity is low, the processing proceeds to step S304. In a case in which the intensity of the interferences is low, the erroneous event quantity due to the interferences is defined as small, and the input event data is output to the processing unit of a subsequent stage without performing correction processing (step S304). Note that, as described with reference to FIG. 17, in a case in which the 2-bit data before correction is converted into and output as 4-bit data, the processing of repeating the 2-bit data before correction and outputting the data as the 4-bit data is executed in step S304.

On the other hand, in a case in which the determination is made in step S303 that the interference intensity is not low, the processing proceeds to step S305. In step S305, whether the interference intensity is medium is determined. In a case in which the determination is made in step S305 that the interference intensity is medium, the processing proceeds to step S306. In step S306, noise events are removed.

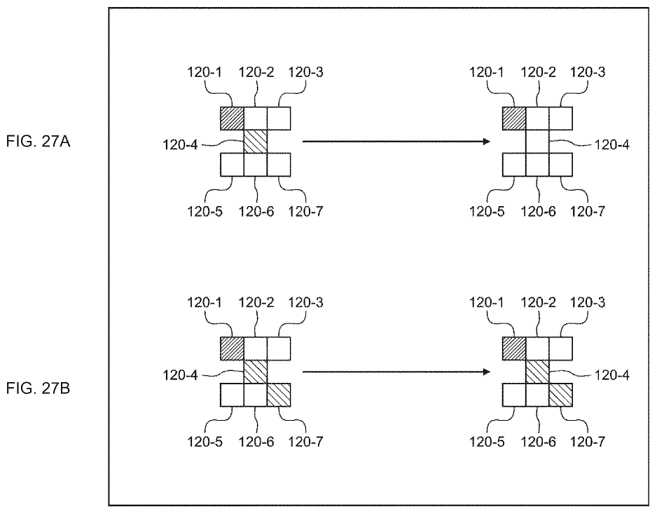

The removal of noise events executed in step S306 will now be described with reference to FIG. 27. In a case in which the interference intensity is medium, normal events are held and, under the assumption that erroneous events caused by interference are applied as noise, processing is executed to remove such noise events.

The left diagram in A of FIG. 27 is a diagram depicting an arrangement of pixels (pixels including the event signal generation section 120) before correction and depicting event data of events that occurred in the event signal generation sections 120. Among pixels 120-1 to 120-7 depicted in A of FIG. 27, the pixel that is located in the target row determined to have a medium interference intensity and set as a correction target is the pixel 120-4.

The pixels that are above the pixel 120-4 that is the target pixel and are in a non-interference row are the pixels 120-1 to 120-3. The pixel 120-1 is located on an upper left side of the target pixel 120-4, the pixel 120-2 is located directly above the target pixel 120-4, and the pixel 120-3 is located on an upper right side of the target pixel 120-4. Note that, although A of FIG. 27 illustrates that the pixels 120-1 to 120-3 are located in a row adjacent to the target pixel 120-4, in a case in which the non-interference row is not adjacent, the pixels 120-1 to 120-3 may be located in a non-interference row at a position separated by several rows.

The pixels that are below the pixel 120-4 that is the target pixel and are in a non-interference row are the pixels 120-5 to 120-7. The pixel 120-5 is located on a lower left side of the target pixel 120-4, the pixel 120-6 is located directly below the target pixel 120-4, and the pixel 120-7 is located on a lower right side of the target pixel 120-4. Note that, although A of FIG. 27 illustrates that the pixels 120-5 to 120-7 are located in a row adjacent to the target pixel 120-4, in a case in which the non-interference row is not adjacent, the pixels 120-5 to 120-7 may be located in a non-interference row at a position separated by several rows.

Hereinafter, description will continue by using such a pixel arrangement as an example. Further, herein, description will continue under the assumption that the pixel in which an event occurs is denoted by diagonal lines, and the target pixel 120-4 is a pixel in which an on-event or an off-event has occurred. In the example depicted in A of FIG. 27, the pixel 120-1 is also a pixel in which an on-event or an off-event has occurred, and is denoted by diagonal lines. Here, a pixel with dense diagonal lines, as applied to the pixel 120-1, is regarded as a pixel in which an on-event has occurred, and a pixel with sparse diagonal lines, as applied to the pixel 120-4, is regarded as a pixel in which an off-event has occurred.

A total of six pixels, namely, the pixels 120-1 to 120-3 which are a pixel located above the target pixel 120-4 and pixels adjacent to the pixel (±1 pixels) in an x direction in the non-interference row located above the target pixel 120-4 in the interference row, and the pixels 120-5 to 120-7 which are a pixel located below the target pixel 120-4 and pixels adjacent to the pixel (±1 pixel) in the x direction in the non-interference row located below the target pixel 120-4, are set as search target pixels. In a case in which an event having the same polarity as that of the event of the target pixel 120-4 does not exist in these six pixels set as the search target pixels, the target pixel is determined to be an isolated point and is set as a noise event to be removed.

In the example depicted in A of FIG. 27, an off-event has not occurred in the six pixels of the search pixels 120-1 to 120-3, and 120-5 to 120-7 with respect to the target pixel 120-4 having the off-event. In this case, the determination is made that there is no event having the same polarity (off-event) as that of the target pixel 120-4 in the search target pixels, and the target pixel is processed as an isolated point. As depicted in the right drawing in A of FIG. 27, the target pixel 120-4 detected with the off-event is corrected to the pixel 120-4 in which no event has occurred.

In this way, in a case in which the event data of the target pixel does not match the event data of any of the plurality of (six in this case) search pixels, the event data of the target pixel is corrected to data of no event.

Reference will now be made to B of FIG. 27. The left drawing in B of FIG. 27 depicts an occurrence example of an event in the pixel arrangement before correction. In the example depicted in the left drawing in B of FIG. 27, an off-event has occurred in the target pixel 120-4, an on-event has occurred in the search target pixel 120-1, and an off-event has occurred in the search target pixel 120-7.

In the case of the event occurrence conditions depicted in B of FIG. 27, an off-event has occurred in the target pixel 120-4, and an off-event has also occurred in the pixel 120-7 that is a search target pixel. In this case, the determination is made that the search target pixel includes an event having the same polarity (off-event) as that of the target pixel 120-4, and the event is held as a normal event. As depicted in the right drawing of B of FIG. 27, the target pixel 120-4 detected with the off-event is treated, as is, as the pixel 120-4 in which the off-event has occurred.

In this way, in a case in which the event data of the target pixel matches the event data of at least one search pixel of the plurality of (six in this case) search pixels, the event data of the target pixel is maintained as is.

Here, a case in which the number of pixels to be searched is six has been described as an example, but a number of pixels less than six or more than six may be set as the number of pixels to be searched.

In this way, in a case in which the interference intensity is medium, correction for removing the isolated point is executed.

Returning to the description with reference to the flowchart of FIG. 26, in a case in which the determination is made in step S305 that the interference intensity is not medium, that is, in this case, when the determination is made that the interference intensity is high, the processing proceeds to step S307. In step S307, correction is executed for all event data. In a case in which the interference intensity is high, there is a possibility that many erroneous events due to interference have occurred, and thus correction is performed on all event data of the target row.

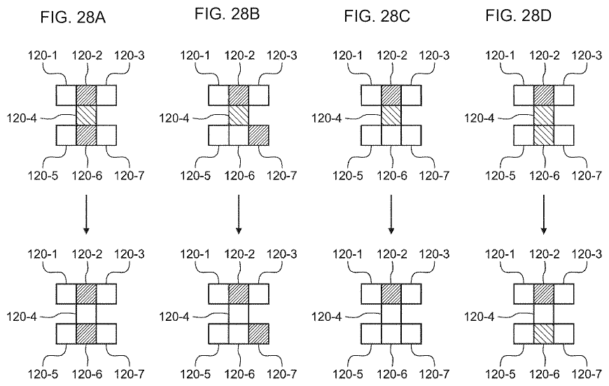

The correction of all event data executed in step S307 will now be described with reference to FIG. 28 to FIG. 30. In FIG. 28 to FIG. 30, the upper portions depict a pixel arrangement and an event occurrence example before correction, and the lower portions depict a pixel arrangement and an event occurrence example after correction. In the pixel arrangement, as in the case depicted in FIG. 27, the pixel to be corrected is the target pixel 120-4, and the event data of the target pixel 120-4 is corrected in accordance with the conditions of event occurrence of the six pixels of the pixels 120-1 to 120-7 (excluding the pixel 120-4) located around the target pixel 120-4.

A correction rule in a case in which the interference intensity is high, which will be described with reference to FIG. 28, is referred to as a correction rule 1. The correction rule 1 is correction by masking, and is correction that deletes the event of the target pixel.

A case in which an off-event has occurred in the target pixel 120-4 will be described as an example. Before correction, as depicted in the upper portion of A of FIG. 28, on-events have occurred in both the pixel 120-2 and the pixel 120-6, which are the search pixels, located immediately above and immediately below the target pixel 120-4. As depicted in the lower portion of A of FIG. 28, since the event of the target pixel is deleted according to correction rule 1, the event of the target pixel 120-4 is deleted, and the event data is corrected to and output as the event data of no event occurrence.

Before correction, as depicted in the upper portion of B of FIG. 28, on-events have occurred in both the pixel 120-2 and the pixel 120-7, which are the search pixels, located immediately above the target pixel 120-4 and located below and to the right of the target pixel 120-4, respectively. As depicted in the lower portion of B of FIG. 28, since the event of the target pixel is deleted according to correction rule 1, the event of the target pixel 120-4 is deleted, and the event data is corrected to and output as the event data of no event occurrence.

Before correction, as depicted in the upper portion of C of FIG. 28, an on-event has occurred in the pixel 120-2, which is the search pixel, located immediately above the target pixel 120-4. As depicted in the lower portion of C of FIG. 28, since the event of the target pixel is deleted according to correction rule 1, the event of the target pixel 120-4 is deleted, and the event data is corrected to and output as the event data of no event occurrence.

Before correction, as depicted in the upper portion of D of FIG. 28, an on-event has occurred in the pixel 120-2, which is the search pixel, located immediately above the target pixel 120-4, and an off-event has occurred in the pixel 120-6, which is the search pixel, located immediately below the target pixel 120-4. As depicted in the lower portion of D of FIG. 28, since the event of the target pixel is deleted according to correction rule 1, the event of the target pixel 120-4 is deleted, and the event data is corrected to and output as the event data of no event occurrence.

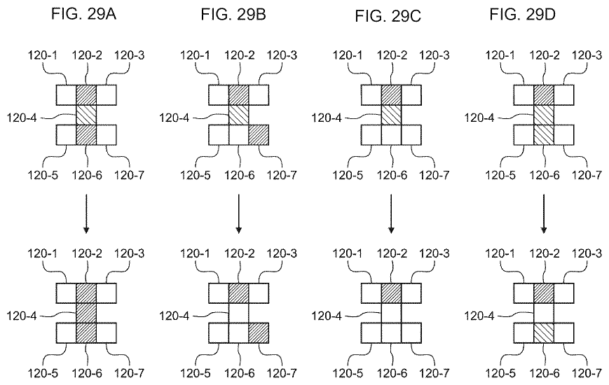

A correction rule 2 in a case in which the interference intensity is high will now be described with reference to FIG. 29. The correction rule 2 is a rule of replacing the event data of the target pixel 120-4 in a case in which events occurring in search pixels located in non-interference rows above and below the target pixel 120-4 and located immediately above and immediately below the target pixel 120-4 match, and deleting the event of the target pixel in a case in which the events do not match.

The examples depicted in the upper portions of A to D of FIG. 29 depict pixel arrangements and event occurrence examples before correction, and depict examples similar to the examples depicted in the upper portions of A to D of FIG. 28.

With reference to the upper portion of A of FIG. 29, before correction, on-events have occurred in both the pixel 120-2 and the pixel 120-6, which are the search pixels, located immediately above and immediately below the target pixel 120-4. Thus, in a case in which the events of the pixels located above and below the target pixel 120-4 match, the event of the target pixel 120-4 is replaced with the matching event. Accordingly, as depicted in the lower portion of A of FIG. 29, although an off-event has occurred in the target pixel 120-4, the off-event is replaced with the on-event occurring in the upper and lower pixels, and the event data is output.

Before correction, as depicted in the upper portion of B of FIG. 29, on-events have occurred in both the pixel 120-2 and the pixel 120-7, which are the search pixels, located immediately above the target pixel 120-4 and located below and to the right of the target pixel 120-4, respectively, and an event has not occurred in, of the search pixels, the pixel 120-6 located immediately below the target pixel 120-4. In such a case, when correction based on correction rule 2 is performed, since the events of the pixels located above and below the target pixel 120-4 do not match, as depicted in the lower portion of B of FIG. 29, the event of the target pixel 120-4 is deleted and replaced with no event, and the event data is output.

Before correction, as depicted in the upper portion of C of FIG. 29, an on-event has occurred in the pixel 120-2, which is the search pixel, located immediately above the target pixel 120-4, and an event has not occurred in the pixel 120-6, which is the search pixel, located immediately below the target pixel 120-4. In such a case, when correction based on correction rule 2 is performed, since the events of the pixels located above and below the target pixel 120-4 do not match, as depicted in the lower portion of C of FIG. 29, the event of the target pixel 120-4 is deleted and replaced with no event, and the event data is output.

Before correction, as depicted in the upper portion of D of FIG. 29, an on-event has occurred in the pixel 120-2, which is the search pixel, located immediately above the target pixel 120-4, and an off-event has occurred in the pixel 120-6, which is the search pixel, located immediately below the target pixel 120-4. In such a case, when correction based on correction rule 2 is performed, since the events of the pixels located above and below the target pixel 120-4 do not match, as depicted in the lower portion of D of FIG. 29, the event of the target pixel 120-4 is deleted and replaced with no event, and the event data is output.

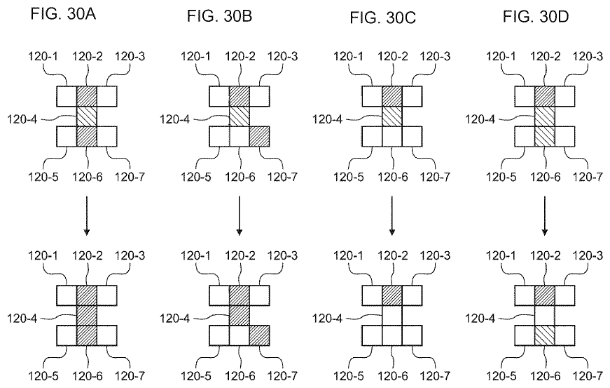

A correction rule 3 in a case in which the interference intensity is high will now be described with reference to FIG. 30. The correction rule 3 is a rule of replacing the event data of the target pixel 120-4 in a case in which events occurring in search pixels located in non-interference rows above and below the target pixel 120-4 and immediately above and immediately below the target pixel 120-4 match each other as well as in a case in which, even when events occurring in the search pixels immediately above and immediately below the target pixel 120-4 do not match each other, the event occurring in the search pixel in the oblique direction, instead of one of the events occurring in the search pixels immediately above or immediately below, matches the other of the events occurring in the search pixels immediately above or immediately below, and deleting the event of the target pixel in a case in which these events do not match each other.

The examples depicted in the upper portions of A to D of FIG. 30 depict pixel arrangements and event occurrence examples before correction, and depict the examples similar to the examples depicted in the upper portions of A to D of FIG. 28.

With reference to the upper portion of A of FIG. 30, before correction, on-events have occurred in both the pixel 120-2 and the pixel 120-6, which are the search pixels, located immediately above and immediately below the target pixel 120-4. Thus, in a case in which the events of the pixels located above and below the target pixel 120-4 match, the event of the target pixel 120-4 is replaced with the matching event. Accordingly, as depicted in the lower portion of A of FIG. 30, although an off-event has occurred in the target pixel 120-4, the off-event is replaced with the on-event occurring in the upper and lower pixels, and the event data is output.

Before correction, as depicted in the upper portion of B of FIG. 30, on-events have occurred in both the pixel 120-2 and the pixel 120-7, which are the search pixels, located immediately above the target pixel 120-4 and located below and to the right of the target pixel 120-4, respectively, and an event has not occurred in the pixel 120-6, which is the search pixel, located immediately below the target pixel 120-4. In such a case, when correction based on correction rule 3 is performed, the events of the pixels located above and below the target pixel 120-4 do not match, but the events of the pixel located above the target pixel 120-4 and the pixel located obliquely below the target pixel 120-4 match as on-events, and thus, as depicted in the lower portion of B of FIG. 30, the event of the target pixel 120-4 is corrected from the off-event to the on-event, and the event data is output.

Before correction, as depicted in the upper portion of C of FIG. 30, an on-event has occurred in the pixel 120-2, which is the search pixel, located immediately above the target pixel 120-4, and an event has not occurred in the pixel 120-6, which is the search pixel, located immediately below the target pixel 120-4. In such a case, when correction based on correction rule 3 is performed, since the events of the pixels located above and below the target pixel 120-4 do not match and the event of the pixel located above or below do not match the events of the pixels located in oblique directions, as depicted in the lower portion of C of FIG. 30, the event of the target pixel 120-4 is deleted and replaced with no event, and the event data is output.

Before correction, as depicted in the upper portion of D of FIG. 30, an on-event has occurred in the pixel 120-2, which is the search pixel, located immediately above the target pixel 120-4, and an off-event has occurred in the pixel 120-6, which is the search pixel, located immediately below the target pixel 120-4. In such a case, when correction based on correction rule 3 is performed, since the events of the pixels located above and below the target pixel 120-4 do not match and the event of the pixel located above or below do not match the events of the pixels located in oblique directions, as depicted in the lower portion of D of FIG. 30, the event of the target pixel 120-4 is deleted and replaced with no event, and the event data is output.

In a case in which the interference intensity is high, any one of the correction rules 1 to 3 is applied to correct the event data of the target pixel. The correction rules 1 to 3 can be configured to be used in combination.

In the embodiment described above, the non-interference row may include the interference row after correction. In other words, the interference row after correction may be treated as a non-interference row when the target row is processed. In such a case, an interference row in which the interference intensity is medium or low and correction is completed is treated as a non-interference row, but an interference row in which the interference intensity is high and correction is completed need not be treated as a non-interference row.

In a case in which there is a non-interference row at a position separated from the target row by a predetermined number of rows or more, the above-described correction processing or the like may be executed by treating an interference row after correction close to the target row as a non-interference row.

### Second Event Data Correction Processing

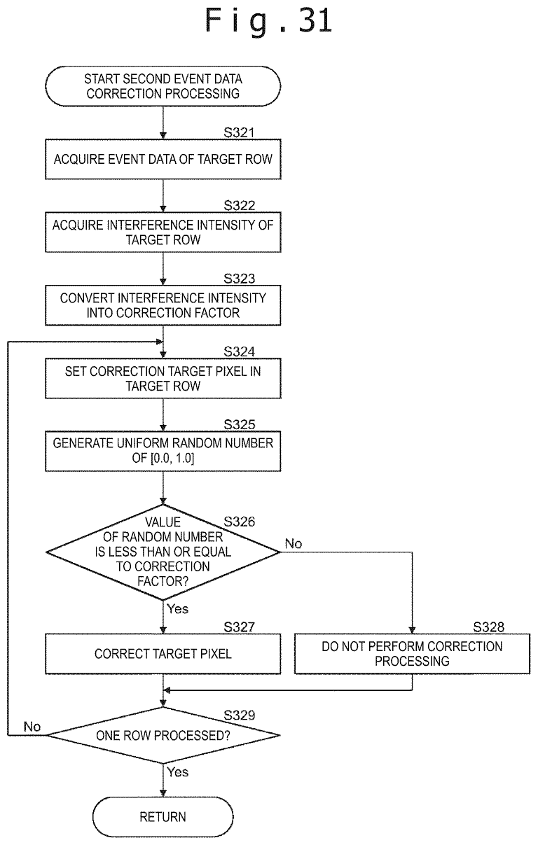

The event data correction processing executed in step S203 will now be further described. FIG. 31 is a flowchart for describing second event data correction processing. The second event data correction processing is correction processing in a case in which the interference intensity is output as a continuous value.

In step S321, the interference correction section 612 acquires the event data of the target row (row subject to processing) output from the event data acquisition section 611. In step S322, the interference correction section 612 acquires the interference intensity of the target row identified by the interference intensity identification section 613. The interference intensity acquired here is a continuous value, such as, for example, a value of 0.8.

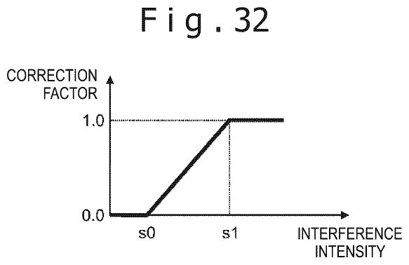

In step S323, the interference intensity is converted into a correction factor. For example, the interference intensity is converted into the correction factor on the basis of a graph shown in FIG. 32. In the graph shown in FIG. 32, the horizontal axis represents interference intensity, and the vertical axis represents correction factor. s0 and s1 shown on the horizontal axis represent control parameters. In a case in which the interference intensity is converted into the correction factor on the basis of the graph shown in FIG. 32, the correction factor is set to “0 ” when the interference intensity is from 0 to s0, and the correction factor is set to “1” when the interference intensity is equal to or greater than s1. When the interference intensity is from s0 to s1, the correction factor is converted into a value represented by a first-order function according to the value of the interference intensity.

Returning to the flowchart depicted in FIG. 31, in step S324, a pixel subject to correction in the target row, such as, for example, a pixel corresponding to the target pixel 120-4 in the case described with reference to FIG. 28 to FIG. 30, is set.

In step S325, a uniform random number of [0.0, 1.0] is generated. In step S326, the generated random number and the converted correction factor are compared, and the determination is made as to whether the value of the random number is equal to or less than the correction factor. Such a determination is performed in order to control the event data quantity to be processed in accordance with the correction factor, that is, for example, to perform control such that the event data quantity to be corrected is reduced in a case in which the correction factor is small and the event data quantity to be corrected is increased in a case in which the correction factor is large.

In step S326, in a case in which the determination is made that the value of the random number is equal to or less than the correction factor, the processing proceeds to step S327. In step S327, the target pixel is corrected.

In step S326, the value of the random number is determined to be equal to or less than the correction factor in a case in which the interference intensity is determined to be high or medium in the first event data correction processing. Accordingly, the processing executed in steps S306 and S307 (FIG. 26) can be applied to the correction of the target pixel executed in step S327.

On the other hand, in step S326, in a case in which the determination is made that the value of the random number is not equal to or less than the correction factor, the processing proceeds to step S328. In step S328, correction processing is not performed on the target pixel, and the event data of the target pixel is output.

In step S326, the value of the random number is determined to not be equal to or less than the correction factor in a case in which the interference intensity is determined to be low in the first event data correction processing. Accordingly, the processing executed in step S304 (FIG. 26), that is, in this case, the processing of not performing the correction processing can be applied to the correction executed in step S328.

When the processing in step S327 or step S328 is completed, the processing proceeds to step S329. In step S329, the determination is made as to whether the pixels of one row have been processed. In step S328, in a case in which the determination is made that there is a pixel that has not been processed in the target row, the processing returns to step S324, and the processing of step S324 and subsequent steps is repeated with the unprocessed pixel in the target row as the processing target.

On the other hand, in a case in which the determination is made in step S329 that all pixels of the target row have been processed, the processing of the flowchart depicted in FIG. 31 is ended, and the processing proceeds to step S204 (FIG. 18).

In step S204, the corrected event data of the target row is output to the processing unit in a subsequent stage.

In this way, the event data is corrected in accordance with the interference intensity. By performing correction according to the interference intensity, it is possible to perform appropriate correction and increase the accuracy of the event data.

### Input/Output Response of Correction Section

The input/output response of the correction section 601 will now be described. By changing the event data input to the correction section 601 and observing the event data output from the correction section 601, it is possible to determine whether the correction section is the correction section 601 to which the present technology is applied or the correction section 601 to which the present technology is not applied.

Event data not affected by interference is prepared, and an interference occurrence flag is applied to the event data not affected by this interference. An erroneous event is applied to a row to which the interference occurrence flag is applied. This applied erroneous event may be an on-event or may be an off-event.

The event data to which the erroneous event is applied is defined as input to the correction section 601, and the output of the correction section 601 is observed. At this time, the application rate of the erroneous event is changed between 0 and 100%, and the output is observed each time the rate is changed. In other words, the interference intensity is changed from low (none) to high, and the output is observed each time the interference intensity is changed.

As described above, in a case in which correction is performed by the correction section 601 to which the present technology is applied, when the application rate of the erroneous event is changed between 0 and 100%, the correction is performed according to the application rate of the erroneous event, in other words, the correction is performed in accordance with the interference intensity, and thus the event data output differs for each application rate. Specifically, the lower the application rate of the erroneous event, the more the original event data is retained in the output.

In a case in which the correction section 601 does not perform correction according to the interference intensity but performs correction uniformly, even if the application rate of the erroneous event changes, the event data output does not change and remains the same.

The output results differ between the correction section 601 to which the present technology is applied and the correction section to which the present technology is not applied. According to the correction section 601 to which the present technology is applied, it is possible to confirm that appropriate correction is performed by such a confirmation method.

### Recording Medium

The series of processing described above can be executed by hardware or can be executed by software. In a case in which the series of processing is executed by software, a program constituting the software is installed in a computer. Herein, a computer includes a computer incorporated in dedicated hardware, a general-purpose personal computer, for example, that can execute various functions by the installation of various programs, and the like.

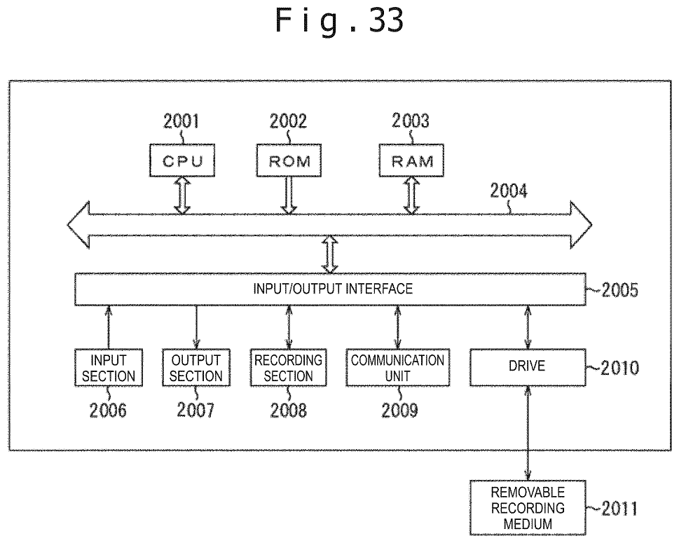

FIG. 33 is a block diagram depicting a configuration example of hardware of a computer that executes the above-described series of processing by a program. In the computer, a central processing unit (CPU) 2001, a read only memory (ROM) 2002, and a random access memory (RAM) 2003 are connected to one another via a bus 2004. Furthermore, an input/output interface 2005 is connected to the bus 2004. An input unit 2006, an output unit 2007, a storage unit 2008, a communication unit 2009, and a drive 2010 are connected to the input/output interface 2005.

The input unit 2006 is composed of a keyboard, a mouse, a microphone, and the like. The output unit 2007 is composed of a display, a speaker, and the like. The storage unit 2008 is composed of a hard disk, a nonvolatile memory, and the like. The communication unit 2009 is composed of a network interface and the like. The drive 2010 drives a removable medium 2011 such as a magnetic disk, an optical disk, a magneto-optical disk, or a semiconductor memory.

In the computer configured as described above, the CPU 2001, for example, loads a program stored in the storage unit 2008 into the RAM 2003 via the input/output interface 2005 and the bus 2004 and executes the program, thereby performing the series of processing described above.

The program executed by the computer (CPU 2001) can be provided by being recorded in the removable medium 2011 as a package medium or the like, for example. Further, the program can be provided via a wired or wireless transmission medium such as a local area network, the Internet, or digital satellite broadcasting.

In the computer, the program can be installed in the storage unit 2008 via the input/output interface 2005 by mounting the removable medium 2011 on the drive 2010. Further, the program can be received by the communication unit 2009 via a wired or wireless transmission medium and installed in the storage unit 2008. In addition, the program can be installed in advance in the ROM 2002 or the storage unit 2008.

Note that the program executed by the computer may be a program in which processing is performed in time series in the order described in the present specification, or may be a program in which processing is performed in parallel or at a necessary timing such as when a call is performed.

### Application Example of Mobile Body

The technology according to the present disclosure (present technology) can be applied to various products. For example, the technology according to the present disclosure may be realized as a device mounted on any type of mobile body such as an automobile, an electric vehicle, a hybrid electric vehicle, a motorcycle, a bicycle, a personal mobility, an airplane, a drone, a ship, and a robot.

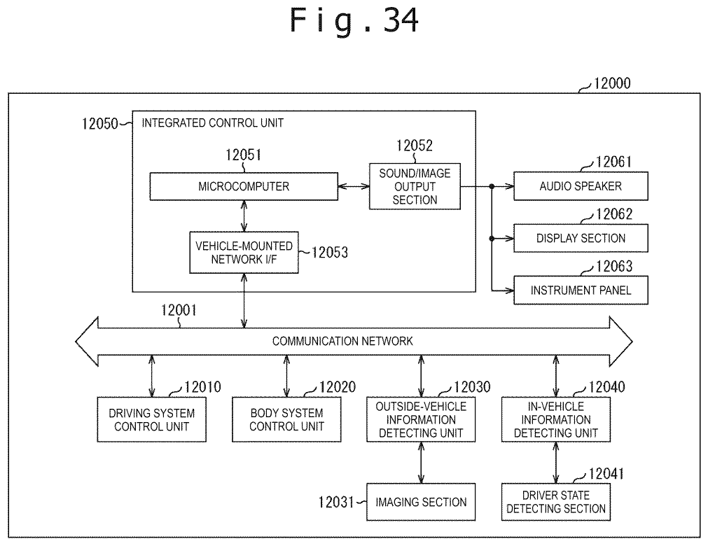

FIG. 34 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 34, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 34, an audio speaker 12061, a display section 12062, and an instrument panel 12063 are illustrated as the output device. The display section 12062 may, for example, include at least one of an on-board display and a head-up display.

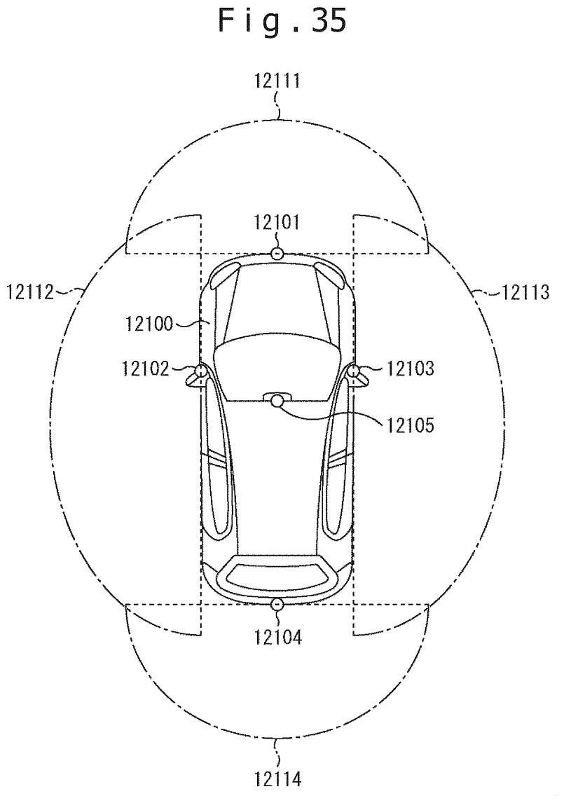

FIG. 35 is a diagram depicting an example of the installation position of the imaging section 12031.

In FIG. 35, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 35 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

In the present specification, the system represents a device as a whole constituted by a plurality of devices.

Note that the effects described in the present specification are merely examples and are not limited, and other effects may be provided.

Note that the embodiments of the present technology are not limited to the embodiments described above, and can be modified within a range that does not depart from the gist of the present technology.

Note that the present technology can also adopt configurations such as the following.
(1) A Light Detection Device Including:
   a pixel array section including a plurality of pixels disposed in a two-dimensional matrix, the plurality of pixels each including an event data generation section configured to detect, as an event, a change in luminance of incident light in the same direction and generate event data based on the event that is detected and a gradation data generation section configured to generate gradation data that is data corresponding to the luminance of the incident light;
   an interference intensity identification section configured to identify an intensity of interference generated by an overlap between a period in which the gradation data is generated and a period in which the event is detected; and
   a correction section configured to correct the event data according to the intensity of the interference identified by the interference intensity identification section.
(2) The light detection device according to (1),
   wherein the pixel array section includes a light-shielded region, and the interference intensity identification section counts an event quantity detected by the event data generation section located in the light-shielded region and identifies the intensity of the interference in accordance with the event quantity that is counted.
(3) The light detection device according to (1),
   wherein the interference intensity identification section
   acquires a first event quantity obtained by counting the events in a target row of the pixel array section, the target row being a row where the intensity of the interference is to be identified,
   acquires a second event quantity in a non-interference row located above the target row and without the interference,
   acquires a third event quantity in a non-interference row located below the target row and without the interference, and
   identifies the intensity of the interference by determining whether a predetermined condition using the first event quantity and either the second event quantity or the third event quantity, whichever is larger, is satisfied.
(4) The light detection device according to (3),
   wherein an interference occurrence flag indicating that an overlap prediction row is detected is acquired, the overlap prediction row being a row in which the overlap between the period in which the gradation data is generated and the period in which the event is detected is predicted, and
   the non-interference row is a row in which the interference occurrence flag is not set.
(5) The light detection device according to (1), comprising
   a table associating the intensity of the interference, information identifying a frame, and a target row of the pixel array section, the target row being a row where the intensity of the interference is to be identified,
   wherein the interference intensity identification section identifies the intensity of the interference of the target row with reference to the table.
(6) The light detection device according to any one of (1) to (5),
   wherein, when the interference intensity identification section identifies the intensity of the interference as low, the correction section does not perform correction.
(7) The light detection device according to any one of (1) to (6),
   wherein, when the interference intensity identification section identifies the intensity of the interference as high, the correction section corrects the event data to event data indicating that an event does not occur in a target pixel subject to correction.
(8) The light detection device according to any one of (1) to (6),
   wherein, when the interference intensity identification section identifies the intensity of the interference as high, the correction section
   acquires a first event of a pixel located immediately above a target pixel subject to correction in a non-interference row located above the target pixel and without the interference, and a second event of a pixel located immediately below the target pixel in a non-interference row located below the target pixel and without the interference,
   corrects the event of the target pixel to event data indicating that the first event occurs when the first event and the second event match, and
   corrects the event to event data indicating that an event does not occur in the target pixel when the first event and the second event do not match.
(9) The light detection device according to any one of (1) to (6),
   wherein, when the interference intensity identification section identifies the intensity of the interference as high, the correction section
   acquires a first event of a pixel located immediately above or in an oblique upward direction from a target pixel subject to correction in a non-interference row located above the target pixel and without the interference and a second event of a pixel located immediately below or in an oblique downward direction from the target pixel in a non-interference row located below the target pixel and without the interference,
   corrects the event of the target pixel to event data indicating that the first event occurs when the first event and the second event match, and
   corrects the event to event data indicating that an event does not occur in the target pixel when the first event and the second event do not match.
(10) The light detection device according to any one of claims (1) to (9),
   wherein, when the interference intensity identification section identifies the intensity of the interference as medium, the correction section
   defines, as search pixels, a pixel located immediately above or in an oblique upward direction from a target pixel subject to correction in a non-interference row located above the target pixel and without the interference and a pixel located immediately below or in an oblique downward direction from the target pixel in a non-interference row located below the target pixel and without the interference,
   maintains the event data of the event of the target pixel when the event of the target pixel and the event of at least one pixel of a plurality of the search pixels match, and
   corrects the event data to event data indicating that the event does not occur in the target pixel when an event matching the event of the target pixel does not occur in any of a plurality of the search pixels.
(11) The light detection device according to any one of (1) to (9),
   wherein the interference intensity identification section outputs the intensity of the interference as a continuous value, and
   the correction section
   converts the continuous value into a correction factor,
   generates a random number,
   corrects the event data of a target pixel subject to processing when the random number is equal to or less than the correction factor, and maintains the event data of the target pixel subject to processing when the random number is not equal to or less than the correction factor.
(12) The light detection device according to any one of claims (1) to (11),
   wherein an input and an output of the correction section are event data having the same number of bits, and
   when the event data that is input is corrected, the event data after correction is output.
(13) The light detection device according to any one of (1) to (11),
   wherein the correction section adds the event data after correction to the event data that is input and outputs the result.
(14) A correction method executed by a light detection device including a pixel array section including a plurality of pixels disposed in a two-dimensional matrix, the plurality of pixels each including an event data generation section configured to detect, as an event, a change in luminance of incident light in the same direction and generate event data based on the event that is detected and a gradation data generation section configured to generate gradation data that is data corresponding to the luminance of the incident light, the correction method including:
   identifying an intensity of interference generated by an overlap between a period in which the gradation data is generated and a period in which the event is detected; and
   correcting the event data according to the intensity of the interference that is identified.
(15) A program for causing a computer configured to control a light detection device, the light detection device including a pixel array section including a plurality of pixels disposed in a two-dimensional matrix, the plurality of pixels each including an event data generation section configured to detect, as an event, a change in luminance of incident light in the same direction and generate event data based on the event that is detected and a gradation data generation section configured to generate gradation data that is data corresponding to the luminance of the incident light, to execute:
   identifying an intensity of interference generated by an overlap between a period in which the gradation data is generated and a period in which the event is detected; and
   correcting the event data according to the intensity of the interference that is identified.

### REFERENCE SIGNS LIST

1 Light detection device, 10 Pixel array section, 11 Signal line, 12 Signal line, 13 Pixel, 14 Pixel, 15 Pixel, 16 Pixel, 17 Pixel, 18 Pixel, 20 Access control circuit, 21 Signal line, 30 Event signal output circuit, 40 Gradation signal output circuit, 50 Timing control unit, 60 Event signal processing unit, 70 Gradation signal processing unit, 80 Overlap prediction row detecting unit, 81 Overlap row prediction section, 90 Time stamp generation unit, 100 Pixel, 110 Gradation signal generation section, 111 MOS transistor, 120 Event signal generation section, 121 Signal line, 130 Photoelectric conversion section, 140 Current-to-voltage conversion circuit, 150 Differentiation circuit, 160 Luminance change detecting section, 170 Output section, 201 Photoelectric conversion section, 202 Photoelectric conversion section, 203 Charge holding section, 204 Capacitor, 205 Capacitor, 231 Constant current circuit, 500 Overlap prediction row, 501 Shutter, 502 Exposure, 503 Readout, 510 Frame, 551 Region, 601 Correction section, 602 Application processor, 612 Interference correction section, 613 Interference intensity identification section, 621 Interference correction section, 651 HOPB region, 652 Effective pixel region, 671 Table

1. A light detection device comprising:
a pixel array section including a plurality of pixels disposed in a two-dimensional matrix, the plurality of pixels each including an event data generation section configured to detect, as an event, a change in luminance of incident light in the same direction and generate event data based on the event that is detected and a gradation data generation section configured to generate gradation data that is data corresponding to the luminance of the incident light;
an interference intensity identification section configured to identify an intensity of interference generated by an overlap between a period in which the gradation data is generated and a period in which the event is detected; and
a correction section configured to correct the event data according to the intensity of the interference identified by the interference intensity identification section.

2. The light detection device according to claim 1,
wherein the pixel array section includes a light-shielded region, and
the interference intensity identification section counts an event quantity detected by the event data generation section located in the light-shielded region and identifies the intensity of the interference in accordance with the event quantity that is counted.

3. The light detection device according to claim 1,
wherein the interference intensity identification section
acquires a first event quantity obtained by counting the events in a target row of the pixel array section, the target row being a row where the intensity of the interference is to be identified,
acquires a second event quantity in a non-interference row located above the target row and without the interference,
acquires a third event quantity in a non-interference row located below the target row and without the interference, and
identifies the intensity of the interference by determining whether a predetermined condition using the first event quantity and either the second event quantity or the third event quantity, whichever is larger, is satisfied.

4. The light detection device according to claim 3,
wherein an interference occurrence flag indicating that an overlap prediction row is detected is acquired, the overlap prediction row being a row in which the overlap between a period in which the gradation data is generated and a period in which the event is detected is predicted, and
the non-interference row is a row in which the interference occurrence flag is not set.

5. The light detection device according to claim 1, comprising
a table associating the intensity of the interference, information identifying a frame, and a target row of the pixel array section, the target row being a row where the intensity of the interference is to be identified,
wherein the interference intensity identification section identifies the intensity of the interference of the target row with reference to the table.

6. The light detection device according to claim 1,
wherein, when the interference intensity identification section identifies the intensity of the interference as low, the correction section does not perform correction.

7. The light detection device according to claim 1,
wherein, when the interference intensity identification section identifies the intensity of the interference as high, the correction section corrects the event data to event data indicating that an event does not occur in a target pixel subject to correction.

8. The light detection device according to claim 1,
wherein, when the interference intensity identification section identifies the intensity of the interference as high, the correction section
acquires a first event of a pixel located immediately above a target pixel subject to correction in a non-interference row located above the target pixel and without the interference and a second event of a pixel located immediately below the target pixel in a non-interference row located below the target pixel and without the interference,
corrects the event of the target pixel to event data indicating that the first event occurs when the first event and the second event match, and
corrects the event to event data indicating that an event does not occur in the target pixel when the first event and the second event do not match.

9. The light detection device according to claim 1,
wherein, when the interference intensity identification section identifies the intensity of the interference as high, the correction section
acquires a first event of a pixel located immediately above or in an oblique upward direction from a target pixel subject to correction in a non-interference row located above the target pixel and without the interference and a second event of a pixel located immediately below or in an oblique downward direction from the target pixel in a non-interference row located below the target pixel and without the interference,
corrects the event of the target pixel to event data indicating that the first event occurs when the first event and the second event match, and
corrects the event to event data indicating that an event does not occur in the target pixel when the first event and the second event do not match.

10. The light detection device according to claim 1,
wherein, when the interference intensity identification section identifies the intensity of the interference as medium, the correction section
defines, as search pixels, a pixel located immediately above or in an oblique upward direction from a target pixel subject to correction in a non-interference row located above the target pixel and without the interference and a pixel located immediately below or in an oblique downward direction from the target pixel in a non-interference row located below the target pixel and without the interference,
maintains the event data of the event of the target pixel when the event of the target pixel and the event of at least one pixel of a plurality of the search pixels match, and corrects the event data to event data indicating that the event does not occur in the target pixel when an event matching the event of the target pixel does not occur in any of a plurality of the search pixels.

11. The light detection device according to claim 1,
wherein the interference intensity identification section outputs the intensity of the interference as a continuous value, and
the correction section
converts the continuous value into a correction factor,
generates a random number,
corrects the event data of a target pixel subject to processing when the random number is equal to or less than the correction factor, and
maintains the event data of the target pixel subject to processing when the random number is not equal to or less than the correction factor.

12. The light detection device according to claim 1,
wherein an input and an output of the correction section are event data having the same number of bits, and
when the event data that is input is corrected, the event data after correction is output.

13. The light detection device according to claim 1,
wherein the correction section adds the event data after correction to the event data that is input and outputs the result.

14. A correction method executed by a light detection device including a pixel array section including a plurality of pixels disposed in a two-dimensional matrix, the plurality of pixels each including an event data generation section configured to detect, as an event, a change in luminance of incident light in the same direction and generate event data based on the event that is detected and a gradation data generation section configured to generate gradation data that is data corresponding to the luminance of the incident light, the correction method including:
identifying an intensity of interference generated by an overlap between a period in which the gradation data is generated and a period in which the event is detected; and
correcting the event data according to the intensity of the interference that is identified.

15. A program for causing a computer configured to control a light detection device, the light detection device including a pixel array section including a plurality of pixels disposed in a two-dimensional matrix, the plurality of pixels each including an event data generation section configured to detect, as an event, a change in luminance of incident light in the same direction and generate event data based on the event that is detected and a gradation data generation section configured to generate gradation data that is data corresponding to the luminance of the incident light, to execute:
identifying an intensity of interference generated by an overlap between a period in which the gradation data is generated and a period in which the event is detected; and correcting the event data according to the intensity of the interference that is identified.
